(19) United States
(12) Patent Application Publication
(10) Pub. No.: US 2025/0224592 A1
(43) Pub. Date: Jul. 10, 2025

(54) OPTICAL SYSTEM AND IMAGING APPARATUS

(71) Applicant: FUJIFILM Corporation, Tokyo (JP)

(72) Inventor: Ryoko TOMIOKA, Saitama-shi (JP)

(73) Assignee: FUJIFILM Corporation, Tokyo (JP)

(21) Appl. No.: 19/090,132

(22) Filed: Mar. 25, 2025

Related U.S. Application Data
(63) Continuation of application No. PCT/JP2023/033224, filed on Sep. 12, 2023.

(30) Foreign Application Priority Data
Sep. 30, 2022 (JP) 2022-159104

(51) Int. Cl. G02B 9/64; G02B 13/00; G02B 15/14

(52) U.S. Cl. CPC G02B 9/64; G02B 13/0045; G02B 15/1461

(57) ABSTRACT

An optical system includes a first stop having a variable opening diameter, three or more lenses that are disposed on an object side with respect to the first stop and that include a positive lens and a negative lens, and a second stop having a fixed opening diameter, in which, in a case where a distance on an optical axis from the first stop to the second stop is denoted by Dst, and a focal length of the optical system is denoted by f, a conditional expression represented by 0.005<|Dst|/f<2 is satisfied.

### CROSS-REFERENCE TO RELATED APPLICATIONS

This application is a continuation application of International Application No. PCT/JP2023/033224, filed on Sep. 12, 2023, which claims priority from Japanese Patent Application No. 2022-159104, filed on Sep. 30, 2022. The entire disclosure of each of the above applications is incorporated herein by reference.

### BACKGROUND

### Technical Field

The disclosed technology relates to an optical system and an imaging apparatus.

### Related Art

In the related art, an optical system provided with a stopper, a stop, or the like separately from a stop for determining an F-number has been known. For example, JP1995-209571A (JP-H07-209571A) discloses an optical system comprising a flare stopper in a focusing lens group that moves during a focusing operation, separately from an aperture stop for determining an F-number, in which an opening diameter of the flare stopper is configured to change during focusing. JP1995-209570A (JP-H07-209570A) discloses an optical system comprising a flare stopper in a focusing lens group that moves during a focusing operation, in which the flare stopper is configured to move independently of movement of the focusing lens group during focusing.

JP2011-107312A discloses a configuration of a zoom lens including, in order from an object side to an image side, a first lens group, a second lens group, and a third lens group, in which a sub-stop is disposed on the image side with respect to the second lens group. JP2016-191766A discloses a zoom lens including, from an object side, a first lens group, a second lens group, a third lens group, and a subsequent lens group, in which a flare cut stop and an Fno stop are provided between the second group and the third group.

JP2002-023050A discloses a configuration of an imaging lens consisting of, in order from an object side, a first lens, and a second lens, in which a stop position is set to be on an image plane side with respect to the second lens, and a flare stopper that restricts an optical path of an off-axis ray is provided between the first lens and the second lens. JP2019-049645A discloses a zoom lens including an aperture stop for determining (restricting) a luminous flux of an open F-number, and a flare cutter.

### SUMMARY

The present disclosure provides an optical system capable of improving image forming performance at an intermediate image height while achieving size reduction and suppressing a decrease in a light quantity in an edge part of an image, and an imaging apparatus comprising the optical system.

According to an aspect of the present disclosure, there is provided an optical system comprising a first stop having a variable opening diameter, three or more lenses that are disposed on an object side with respect to the first stop and that include a positive lens and a negative lens, and a second stop having a fixed opening diameter, in which, in a case where a distance on an optical axis from the first stop to the second stop is denoted by Dst, a focal length of the optical system is denoted by f, and in a case where the optical system is a variable magnification optical system, values of Dst and f in a magnification state where a height of an on-axis marginal ray from the optical axis at a position of the second stop is maximum are used, Conditional Expression (1) is satisfied, which is represented by

$$0.005 < \vert Dst \vert / f < 2. \qquad ( 1 )$$

In a case where the opening diameter of the first stop in an open state is denoted by φF, the opening diameter of the second stop is denoted by φS, and in a case where the optical system is the variable magnification optical system, values of φF and φS in the magnification state where the height of the on-axis marginal ray from the optical axis at the position of the second stop is maximum are used, the optical system of the aspect preferably satisfies Conditional Expression (2) represented by

$$0.3 < φ S / φ F < 2.5 . \qquad ( 2 )$$

In a configuration in which a lens surface of a convex shape in contact with air is positioned in an opening of the second stop, in a case where a distance on the optical axis from an intersection between the lens surface and the optical axis to the second stop having the opening in which the lens surface is positioned is denoted by Dp, for Dp, a sign of a distance on an image side is positive, and a sign of a distance on the object side is negative, with reference to the intersection, and a paraxial curvature radius of the lens surface is denoted by Rp, the optical system of the aspect preferably satisfies Conditional Expression (3) represented by

$$0 < Dp / Rp < 0.4 . \qquad ( 3 )$$

In a configuration in which a lens surface of a convex shape in contact with air is positioned in an opening of the second stop, in a case where a distance on the optical axis from an intersection between the lens surface and the optical axis to the second stop having the opening in which the lens surface is positioned is denoted by Dp, for Dp, a sign of a distance on an image side is positive, and a sign of a distance on the object side is negative, with reference to the intersection, a paraxial curvature radius of the lens surface is denoted by Rp, and an effective diameter of the lens surface is denoted by φEp, the optical system of the aspect preferably satisfies Conditional Expression (4) represented by

$$0.7 < \{ Rp - Rp \times {( 1 - {( φ Ep / 2 )}^{2} / {Rp}^{2} )}^{1 / 2} \} / Dp < 1.5 . \qquad ( 4 )$$

In a configuration in which a lens surface of a concave shape in contact with air is positioned adjacent to the second stop, in a case where a distance on the optical axis from an intersection between the lens surface and the optical axis to the second stop is denoted by Dn, for Dn, a sign of a distance on an image side is positive, and a sign of a distance on the object side is negative, with reference to the intersection, a paraxial curvature radius of the lens surface is denoted by Rn, in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn and Rn, and in a case where the optical system is the variable magnification optical system, a value of Dn in the magnification state where the height of the on-axis marginal ray from the optical axis at the position of the second stop is maximum is used, the optical system of the aspect preferably satisfies Conditional Expression (5) represented by

$$0 < Dn / Rn < 0.4 . \qquad ( 5 )$$

In a configuration in which a lens surface of a concave shape in contact with air is positioned adjacent to the second stop, in a case where a distance on the optical axis from an intersection between the lens surface and the optical axis to the second stop is denoted by Dn, for Dn, a sign of a distance on an image side is positive, and a sign of a distance on the object side is negative, with reference to the intersection, a paraxial curvature radius of the lens surface is denoted by Rn, an effective diameter of the lens surface is denoted by φEn, in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn, Rn, and φEn, and in a case where the optical system is the variable magnification optical system, a value of Dn in the magnification state where the height of the on-axis marginal ray from the optical axis at the position of the second stop is maximum is used, the optical system of the aspect preferably satisfies Conditional Expression (6) represented by

$$0.5 < \{ Rn - Rn \times {( 1 - {( φ En / 2 )}^{2} / {Rn}^{2} )}^{1 / 2} \} / Dn < 1.2 . \qquad ( 6 )$$

In a case where a height of a principal ray having a maximum image height from the optical axis at the position of the second stop is denoted by hp, the height of the on-axis marginal ray from the optical axis at the position of the second stop is denoted by hm, and in a case where the optical system is the variable magnification optical system, values of hp and hm in the magnification state where the height of the on-axis marginal ray from the optical axis at the position of the second stop is maximum are used, the optical system of the aspect preferably satisfies Conditional Expression (7) represented by

$$0 < \vert h p \vert / hm < 1. \qquad ( 7 )$$

In a case where a sum of a distance on the optical axis from a lens surface of the optical system closest to the object side to a lens surface of the optical system closest to an image side and a back focus of the optical system as an air conversion distance is denoted by TL, a height of a principal ray having a maximum image height from the optical axis at the position of the second stop is denoted by hp, the height of the on-axis marginal ray from the optical axis at the position of the second stop is denoted by hm, and in a case where the optical system is the variable magnification optical system, values of Dst, TL, hp, and hm in the magnification state where the height of the on-axis marginal ray from the optical axis at the position of the second stop is maximum are used, the optical system of the aspect preferably satisfies Conditional Expression (8) represented by

$$0.05 < ( \vert Dst \vert / TL ) / ( \vert h p \vert / hm ) < 1.8 . \qquad ( 8 )$$

In a case where one lens component is one single lens or one cemented lens, a combined focal length of all lens components on the object side with respect to the second stop is denoted by fs, and in a case where the optical system is the variable magnification optical system, values of f and fs in the magnification state where the height of the on-axis marginal ray from the optical axis at the position of the second stop is maximum are used, the optical system of the aspect preferably satisfies Conditional Expression (9) represented by

$$- 5 < f / fs < 5. \qquad ( 9 )$$

It is preferable that the second stop moves in an integrated manner with at least one lens of the optical system during focusing, or the second stop is fixed with respect to an image plane in an integrated manner with at least one lens of the optical system during focusing. In a case where the optical system is the variable magnification optical system, it is preferable that the second stop moves in an integrated manner with at least one lens of the optical system during changing magnification, or the second stop is fixed with respect to the image plane in an integrated manner with at least one lens of the optical system during changing the magnification.

The first stop may be configured to be a stop for determining an F-number.

According to another aspect of the present disclosure, there is provided an imaging apparatus comprising the optical system according to the aspect of the present disclosure.

In the present specification, the term “single lens” means one non-cemented lens. A compound aspherical lens (a lens that is composed of a spherical lens and a film of an aspherical shape formed on the spherical lens in an integrated manner and that functions as one aspherical lens as a whole) is not regarded as a cemented lens and is treated as one lens. Unless otherwise specified, a sign of a refractive power and a surface shape related to a lens including an aspherical surface in a paraxial region are used.

The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on a d line in the state where the infinite distance object is in focus. The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13nanometers (nm). A wavelength of the g line is 435.84 nanometers (nm).

According to the present disclosure, an optical system capable of improving image forming performance at an intermediate image height while achieving size reduction and suppressing a decrease in a light quantity in an edge part of an image, and an imaging apparatus comprising the optical system can be provided.

### BRIEF DESCRIPTION OF THE DRAWINGS

FIG. 1 is a cross-sectional view that corresponds to an optical system of Example 1 and that illustrates a configuration of an optical system according to one embodiment.

FIG. 2 is a cross-sectional view illustrating a configuration and luminous fluxes of the optical system in FIG. 1.

FIG. 3 is a diagram for describing symbols of conditional expressions.

FIG. 4 is a spherical aberration diagram, an astigmatism diagram, a distortion diagram, and a lateral chromatic aberration diagram of the optical system of Example 1.

FIG. 5 is a lateral aberration diagram of the optical system of Example 1.

FIG. 6 is a cross-sectional view illustrating a configuration and luminous fluxes in a case where a sub-stop St1 is removed from the optical system in FIG. 2.

FIG. 7 is a lateral aberration diagram of the optical system in FIG. 6.

FIG. 8 is a cross-sectional view illustrating a configuration and luminous fluxes of an optical system of Example 2.

FIG. 9 is each aberration diagram of the optical system of Example 2.

FIG. 10 is a cross-sectional view illustrating a configuration and luminous fluxes of an optical system of Example 3.

FIG. 11 is each aberration diagram of the optical system of Example 3.

FIG. 12 is a cross-sectional view illustrating a configuration and luminous fluxes of an optical system of Example 4.

FIG. 13 is each aberration diagram of the optical system of Example 4.

FIG. 14 is a cross-sectional view illustrating a configuration and luminous fluxes of an optical system of Example 5.

FIG. 15 is each aberration diagram of the optical system of Example 5.

FIG. 16 is a cross-sectional view illustrating a configuration and luminous fluxes of an optical system of Example 6.

FIG. 17 is each aberration diagram of the optical system of Example 6.

FIG. 18 is a perspective view of a front surface side of an imaging apparatus according to one embodiment.

FIG. 19 is a perspective view of a rear surface side of the imaging apparatus according to one embodiment.

### DETAILED DESCRIPTION

Hereinafter, an embodiment of the present disclosure will be described with reference to the drawings.

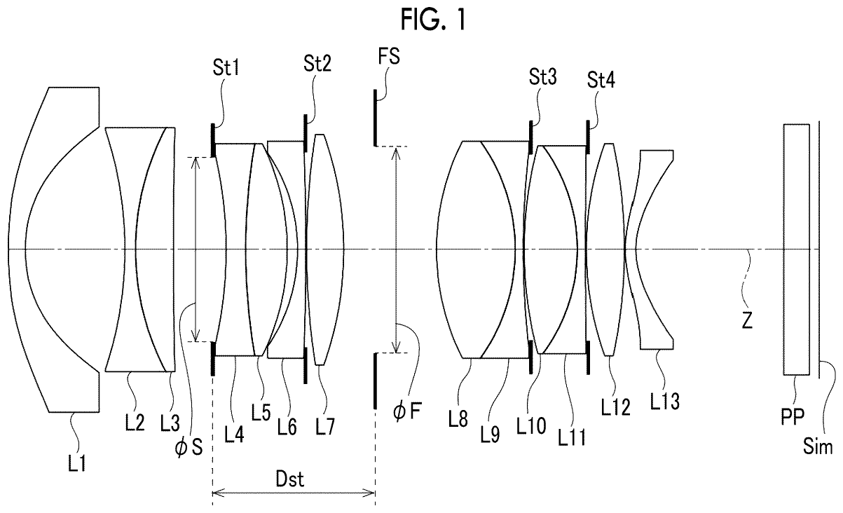

FIG. 1 is a cross-sectional view of a configuration of an optical system according to one embodiment of the present disclosure. In FIG. 1, a left side is an object side, and a right side is an image side. The example illustrated in FIG. 1 corresponds to an optical system of Example 1 described later.

For example, the optical system in FIG. 1 comprises, in order from the object side to the image side, 13 lenses including lenses L1 to L13.

The example in FIG. 1 assumes application of the optical system to an imaging apparatus. Thus, an example in which an optical member PP having a parallel flat plate shape is disposed between a lens closest to the image side and an image plane Sim is shown. The optical member PP is a member that is assumed to be various filters and/or a cover glass or the like. The various filters include a low-pass filter, an infrared cut filter, and/or a filter or the like that cuts a specific wavelength range. The optical member PP is a member not having a refractive power. The imaging apparatus can also be configured without the optical member PP.

The optical system in FIG. 1 comprises a main stop FS having a variable opening diameter, and four sub-stops St1 to St4 having fixed opening diameters.

The main stop FS corresponds to a “first stop” of the disclosed technology. In the example in FIG. 1, the main stop FS functions as a stop for determining an F-number. For example, in the optical system in FIG. 1, the main stop FS is disposed between the lens L7 and the lens L8.

Three or more lenses including a positive lens and a negative lens are disposed on the object side with respect to the main stop FS. Such a configuration enables favorable correction of various aberrations, particularly a spherical aberration and an axial chromatic aberration, occurring on the object side with respect to the main stop FS.

The sub-stops St1 to St4 correspond to a “second stop” of the disclosed technology. For example, in the optical system in FIG. 1, the sub-stops St1 to St4 are disposed as follows. The sub-stop St1 is disposed adjacent to the object side with respect to a surface of the lens L4 on the object side. The sub-stop St2 is disposed to include a surface of the lens L6 on the image side in its opening. The sub-stop St3 is disposed adjacent to the image side with respect to a surface of the lens L9 on the image side. The sub-stop St4 is disposed adjacent to the image side with respect to a surface of the lens L11 on the image side. In the present specification, the term “adjacent” does not necessarily mean being in contact and means being next to each other.

In the following description, the sub-stops St1 to St4 will be simply referred to as the “sub-stop” unless distinction therebetween is necessary. While the optical system in FIG. 1 comprises four sub-stops St1 to St4, the number of sub-stops comprised in the optical system can be set to any number in the disclosed technology.

The opening diameter of the sub-stop is not variable and is unchanging. Configuring the sub-stop to have an unchanging opening diameter eliminates need for a mechanism that changes the opening diameter of the sub-stop and thus, can contribute to size reduction and suppress complication of a mechanical mechanism.

Providing the sub-stop separately from the main stop FS for determining the F-number can provide light shielding against an adverse ray that decreases image forming performance by generating a coma flare or the like at an intermediate image height. This can suppress the coma flare or the like at the intermediate image height and thus, can improve the image forming performance at the intermediate image height. In order to block the adverse ray having the intermediate image height, an optical system provided with a stop or a stopper separately from a stop for determining an F-number in the related art may also provide light shielding against a ray having the maximum image height. In this case, a problem arises in that a light quantity in an edge part of the image is decreased. In order to avoid this problem, it is preferable to dispose the sub-stop near the main stop FS.

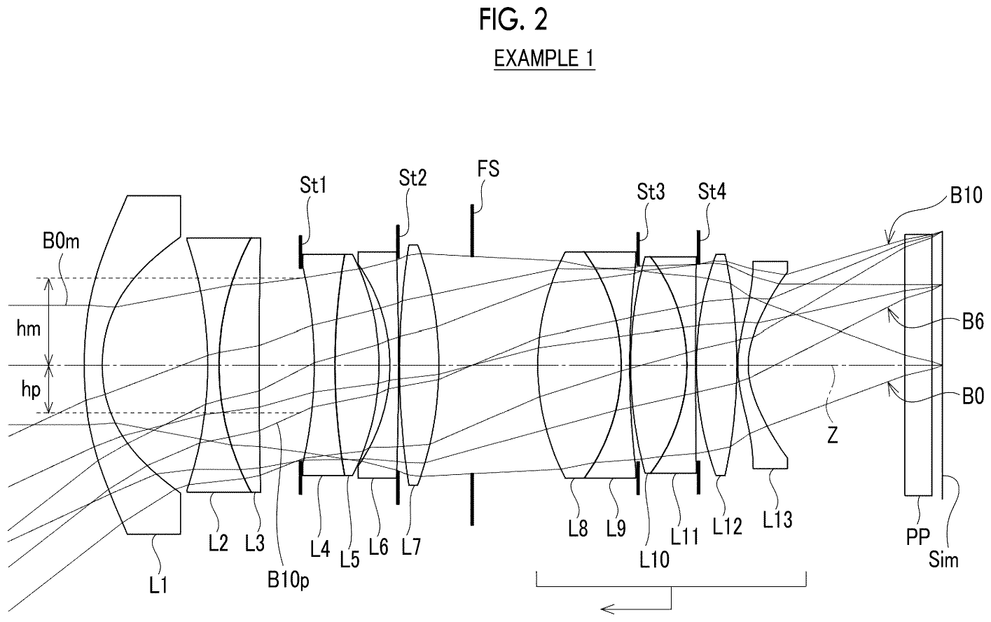

Therefore, in the optical system of the present disclosure, the sub-stop is disposed to satisfy Conditional Expression (1). A distance on an optical axis from the main stop FS to the sub-stop is denoted by Dst. A focal length of the optical system is denoted by f. In a case where the optical system is a variable magnification optical system, values of Dst and f in a magnification state where a height of an on-axis marginal ray B0m (refer to FIG. 2) from an optical axis Z at a position of the sub-stop is maximum are used. For example, FIG. 1 illustrates the distance Dst on the optical axis from the main stop FS to the sub-stop St1.

$$0.005 < \vert Dst \vert / f < 2 \qquad ( 1 )$$

Ensuring that a corresponding value of Conditional Expression (1) is not greater than or equal to its upper limit prevents the position of the sub-stop from being excessively far from the main stop FS and thus, facilitates preventing the sub-stop from providing light shielding against a ray having the maximum image height. This can suppress a decrease in the light quantity in the edge part of the image while providing light shielding against the adverse ray having the intermediate image height. Disposing the sub-stop near the main stop FS to ensure that the corresponding value of Conditional Expression (1) is not greater than or equal to its upper limit can reduce an outer diameter of a lens near the main stop FS and thus, achieves an advantage in achieving size reduction of the optical system. For example, in a case where a focus group that moves during focusing is disposed near the main stop FS, and the sub-stop is disposed in the focus group, the outer diameter of the lens of the focus group can be reduced, and thus, weight reduction of the focus group can be achieved. This achieves an advantage in achieving high-speed focusing. For example, in a case where the sub-stop is disposed in a moving group that moves during changing magnification, the outer diameter of the lens of the moving group can be reduced, and thus, weight reduction of the moving group can be achieved. This achieves an advantage in reducing a load of a drive system for driving the moving group. Ensuring that the corresponding value of Conditional Expression (1) is not less than or equal to its lower limit prevents the sub-stop from being excessively close to the main stop FS and thus, facilitates disposition of the sub-stop without interference between a main stop unit including a mechanism and the like for changing the opening diameter of the main stop FS and the sub-stop.

In order to obtain more favorable characteristics, it is preferable to set the upper limit of Conditional Expression (1) to any of 1.9, 1.8, 1.7, 1.6, 1.5, 1.4, or 1.3 instead of 2. It is preferable to set the lower limit of Conditional Expression (1) to 0.007 or 0.008 instead of 0.005.

FIG. 2 illustrates a cross-sectional view of a configuration and luminous fluxes of the optical system in FIG. 1. As the luminous fluxes, FIG. 2 illustrates an on-axis luminous flux B0, a luminous flux B6 having a 60% image height, and a luminous flux B10 having the maximum image height and also illustrates the on-axis marginal ray B0m. The sub-stops St1 to St4 provide light shielding against the adverse ray having the 60% image height without providing light shielding against the on-axis luminous flux B0 and the luminous flux B10 having the maximum image height. The term “60% image height” indicates a ratio of an image height to the maximum image height with the maximum image height being a 100% image height, and this definition also applies to other image heights in the present specification. While FIG. 2 illustrates a luminous flux having the 60% image height as an example of a luminous flux having the intermediate image height, the “intermediate image height” of the disclosed technology is not limited to the 60% image height. An image height greater than 0 and less than the maximum image height can be referred to as the “intermediate image height”.

Hereinafter, conditional expressions further satisfied by the optical system of the present disclosure will be described. In the following description related to the conditional expressions, in order to avoid redundant description, the same symbol will be used for the same definition to partially omit duplicate descriptions of the symbol.

The optical system of the present disclosure preferably satisfies Conditional Expression (2). The opening diameter of the main stop FS in an open state is denoted by φF. The opening diameter of the sub-stop is denoted by φS. In a case where the optical system is the variable magnification optical system, values of φF and φS in the magnification state where the height of the on-axis marginal ray B0m from the optical axis Z at the position of the sub-stop is maximum are used. For example, FIG. 1 illustrates the opening diameter φF of the main stop FS in the open state and the opening diameter φS of the sub-stop St1.

$$0.3 < φ S / φ F < 2.5 \qquad ( 2 )$$

Ensuring that a corresponding value of Conditional Expression (2) is not greater than or equal to its upper limit prevents an excessively large opening diameter of the sub-stop and thus, facilitates light shielding against the adverse ray. Ensuring that the corresponding value of Conditional Expression (2) is not less than or equal to its lower limit prevents an excessively small opening diameter of the sub-stop and thus, facilitates configuring the sub-stop not to provide light shielding against an on-axis ray.

In order to obtain more favorable characteristics, it is preferable to set the upper limit of Conditional Expression (2) to any of 2.3, 2.2, 2.1, 2, or 1.9 instead of 2.5. It is preferable to set the lower limit of Conditional Expression (2) to any of 0.4, 0.45, 0.5, 0.55, 0.6, or 0.65 instead of 0.3.

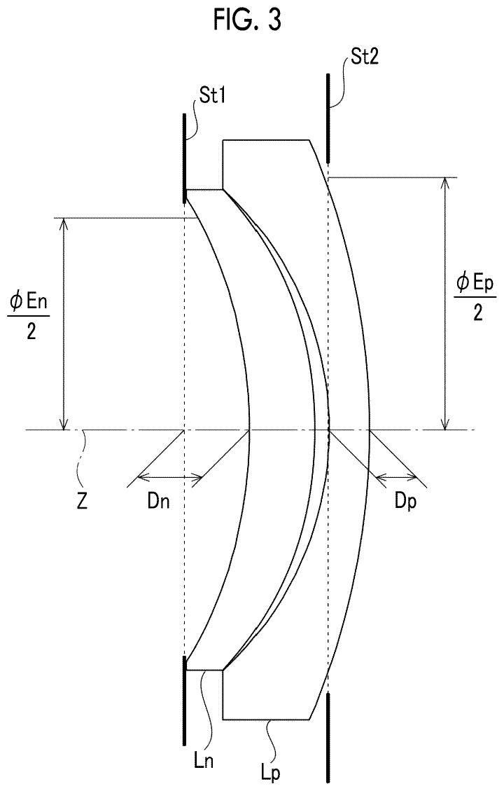

In a case where a lens surface of a convex shape in contact with air is positioned in an opening of the sub-stop, the optical system of the present disclosure preferably satisfies Conditional Expression (3). For example, FIG. 3 illustrates a configuration in which a surface of a lens Lp on the image side is positioned in the opening of the sub-stop St2. In FIG. 3, a left side is the object side, and a right side is the image side. The surface of the lens Lp on the image side is a surface of a convex shape in contact with air. A distance on the optical axis from an intersection between the lens surface and the optical axis Z to the sub-stop having an opening in which the lens surface is positioned is denoted by Dp. A paraxial curvature radius of the lens surface is denoted by Rp. For example, FIG. 3 illustrates the distance Dp. For a sign of Dp, a sign of a distance on the image side is positive, and a sign of a distance on the object side is negative, with reference to the intersection. For a sign of the paraxial curvature radius in the present specification, a sign of the paraxial curvature radius of a surface having a convex shape facing the object side is positive, and a sign of the paraxial curvature radius of a surface having a convex shape facing the image side is negative.

$$0 < Dp / Rp < 0.4 \qquad ( 3 )$$

Ensuring that a corresponding value of Conditional Expression (3) is not greater than or equal to its upper limit can suppress values of a diameter of an effective optical surface of the lens and an effective diameter of the lens being close to each other and thus, achieves an advantage in improving workability and assembly. Ensuring that the corresponding value of Conditional Expression (3) is not less than or equal to its lower limit prevents the lens having the lens surface from being excessively far from the sub-stop having the opening in which the lens surface is positioned, and thus, enables the sub-stop to be disposed without increasing the total length of the optical system. This achieves an advantage in size reduction. In a case where the lens having the lens surface is excessively far from the sub-stop having the opening in which the lens surface is positioned, a space for disposing the sub-stop is necessary, and the total length of the optical system may be increased.

In order to obtain more favorable characteristics, it is preferable to set the upper limit of Conditional Expression (3) to any of 0.35, 0.3, 0.25, 0.2, 0.19, or 0.18 instead of 0.4.

In the present specification, the term “effective optical surface” means a surface usable as an optical surface. In the present specification, the term “effective diameter” means twice a distance from an intersection between a ray passing through the most outer side and a lens surface to the optical axis Z among rays that are incident on the lens surface from the object side and that exit to the image side. The term “outer side” means an outer side in a diameter direction centered on the optical axis Z, that is, a side away from the optical axis Z. In a case where the optical system is the variable magnification optical system, the “ray passing through the most outer side” is determined by considering the entire magnification range.

In a case where a lens surface of a convex shape in contact with air is positioned in the opening of the sub-stop, the optical system of the present disclosure preferably satisfies Conditional Expression (4). An effective diameter of the lens surface is denoted by φEp. For example, FIG. 3 illustrates a half value of the effective diameter φEp.

$$0.7 < \{ Rp - Rp \times {( 1 - {( φ Ep / 2 )}^{2} / {Rp}^{2} )}^{1 / 2} \} / Dp < 1.5 \qquad ( 4 )$$

Ensuring that a corresponding value of Conditional Expression (4) is not greater than or equal to its upper limit can suppress an increase in the opening diameter of the sub-stop and thus, facilitates effective light shielding against the adverse ray. Ensuring that the corresponding value of Conditional Expression (4) is not less than or equal to its lower limit facilitates prevention of light shielding against not only the adverse ray but also a necessary ray.

In order to obtain more favorable characteristics, it is preferable to set the upper limit of Conditional Expression (4) to any of 1.4, 1.35, 1.3, 1.25, 1.2, or 1.15 instead of 1.5. It is preferable to set the lower limit of Conditional Expression (4) to any of 0.75, 0.8, 0.85, 0.91, 0.92, 0.93, 0.94, 0.95, 0.96, 0.97, 0.98, or 0.99 instead of 0.7.

In a case where a lens surface of a concave shape in contact with air is positioned adjacent to the sub-stop, the optical system of the present disclosure preferably satisfies Conditional Expression (5). For example, FIG. 3 illustrates a configuration in which a surface of a lens Ln on the object side is positioned adjacent to the sub-stop St1. The surface of the lens Ln on the object side is a surface of a concave shape in contact with air. A distance on the optical axis from an intersection between the lens surface of the concave shape and the optical axis Z to the sub-stop is denoted by Dn. A paraxial curvature radius of the lens surface of the concave shape is denoted by Rn. For example, FIG. 3 illustrates the distance Dn. For a sign of Dn, a sign of a distance on the image side is positive, and a sign of a distance on the object side is negative, with reference to the intersection. In a case where two lens surfaces of concave shapes in contact with air are positioned adjacent to one sub-stop, that is, in a case where the lens surfaces of the concave shape in contact with air are positioned adjacent to the object side and the image side with respect to the sub-stop, a value of a lens surface having the diameter of the effective optical surface closer to the value of the opening diameter of the sub-stop out of the two lens surfaces is used for Dn and Rn. In a case where the optical system is the variable magnification optical system, a value of Dn in the magnification state where the height of the on-axis marginal ray B0m from the optical axis Z at the position of the sub-stop is maximum is used.

$$0 < Dn / Rn < 0.4 \qquad ( 5 )$$

Ensuring that a corresponding value of Conditional Expression (5) is not greater than or equal to its upper limit prevents the lens surface of the concave shape from being excessively far from the sub-stop and thus, enables the sub-stop to be disposed without increasing the total length of the optical system. This achieves an advantage in size reduction. Ensuring that the corresponding value of Conditional Expression (5) is not less than or equal to its lower limit can provide effective light shielding against the adverse ray.

In order to obtain more favorable characteristics, it is preferable to set the upper limit of Conditional Expression (5) to any of 0.3, 0.25, 0.2, 0.15, 0.13, 0.1, or 0.05 instead of 0.4.

In a case where a lens surface of a concave shape in contact with air is positioned adjacent to the sub-stop, the optical system of the present disclosure preferably satisfies Conditional Expression (6). An effective diameter of the lens surface of the concave shape is denoted by φEn. For example, FIG. 3 illustrates a half value of the effective diameter φEn.

$$0.5 < \{ Rn - Rn \times {( 1 - {( φ En / 2 )}^{2} / {Rn}^{2} )}^{1 / 2} \} / Dn < 1.2 \qquad ( 6 )$$

Ensuring that a corresponding value of Conditional Expression (6) is not greater than or equal to its upper limit can suppress the values of the diameter of the effective optical surface of the lens and the effective diameter of the lens being close to each other and thus, achieves an advantage in improving workability and assembly. Ensuring that the corresponding value of Conditional Expression (6) is not less than or equal to its lower limit prevents the lens surface of the concave shape from being excessively far from the sub-stop and thus, enables the sub-stop to be disposed without increasing the total length of the optical system. This achieves an advantage in size reduction.

In order to obtain more favorable characteristics, it is preferable to set the upper limit of Conditional Expression (6) to any of 1.1, 1.08, 1.06, 1.05, 1.04, 1.03, 1.02, or 1.01 instead of 1.2. It is preferable to set the lower limit of Conditional Expression (6) to any of 0.55, 0.6, 0.65, 0.7, 0.75, or 0.8 instead of 0.5.

The optical system of the present disclosure preferably satisfies Conditional Expression (7) with respect to a ray height. A height of a principal ray B10p having the maximum image height from the optical axis Z at the position of the sub-stop is denoted by hp. The height of the on-axis marginal ray B0m from the optical axis Z at the position of the sub-stop is denoted by hm. In a case where the optical system is the variable magnification optical system, values of hp and hm in the magnification state where the height of the on-axis marginal ray B0m from the optical axis Z at the position of the sub-stop is maximum are used. For example, FIG. 2 illustrates the principal ray B10p having the maximum image height and the on-axis marginal ray B0m and illustrates hp and hm related to the sub-stop St1.

$$0 < \vert h p \vert / hm < 1 \qquad ( 7 )$$

Ensuring that a corresponding value of Conditional Expression (7) is not greater than or equal to its upper limit enables the sub-stop to be disposed at a position at which the height of the principal ray B10p having the maximum image height is smaller than the height of the on-axis marginal ray B0m. This facilitates light shielding against only the adverse ray having the intermediate image height while securing the edge part light quantity at the maximum image height. For a lower limit of Conditional Expression (7), |hp|/hm>0 is established because of |hp|>0 and hm>0.

In order to obtain more favorable characteristics, it is preferable to set the upper limit of Conditional Expression (7) to any of 0.95, 0.9, or 0.85 instead of 1.

The optical system of the present disclosure preferably satisfies Conditional Expression (8). A sum of a distance on the optical axis from a lens surface of the optical system closest to the object side to a lens surface of the optical system closest to the image side and a back focus of the optical system as an air conversion distance is denoted by TL. TL denotes the total length of the optical system. In a case where the optical system is the variable magnification optical system, values of Dst, TL, hp, and hm in the magnification state where the height of the on-axis marginal ray B0m from the optical axis Z at the position of the sub-stop is maximum are used.

$$0.05 < ( \vert Dst \vert / TL ) / ( \vert h p \vert / hm ) < 1.8 \qquad ( 8 )$$

Ensuring that a corresponding value of Conditional Expression (8) is not greater than or equal to its upper limit prevents the position of the sub-stop from being excessively far from the main stop FS and thus, can prevent the sub-stop from providing light shielding against even the ray having the maximum image height. This can suppress a decrease in the light quantity in the edge part of the image. Ensuring that the corresponding value of Conditional Expression (8) is not less than or equal to its lower limit prevents the sub-stop from being excessively close to the main stop FS and thus, facilitates disposition of the sub-stop without interference between the main stop unit including the mechanism and the like for changing the opening diameter of the main stop FS and the sub-stop.

In order to obtain more favorable characteristics, it is preferable to set the upper limit of Conditional Expression (8) to any of 1.7, 1.6, 1.5, 1.4, 1.3, 1.2, 1.1, 1, or 0.9 instead of 1.8. It is preferable to set the lower limit of Conditional Expression (8) to any of 0.06, 0.07, 0.08, 0.09, 0.1, 0.11, or 0.12 instead of 0.05.

The optical system of the present disclosure preferably satisfies Conditional Expression (9). A combined focal length of all lens components on the object side with respect to the sub-stop is denoted by fs. One lens component means one single lens or one cemented lens. In a case where the optical system is the variable magnification optical system, values of f and fs in the magnification state where the height of the on-axis marginal ray B0m from the optical axis Z at the position of the sub-stop is maximum are used.

$$- 5 < f / fs < 5 \qquad ( 9 )$$

Ensuring that a corresponding value of Conditional Expression (9) is not greater than or equal to its upper limit in a range of f/fs>0 facilitates effective light shielding against the adverse ray having the intermediate image height without causing the sub-stop to provide light shielding against even the ray having the maximum image height. Ensuring that the corresponding value of Conditional Expression (9) is not less than or equal to its lower limit in a range of f/fs<0 can prevent significant divergence of the luminous fluxes near the sub-stop and thus, facilitates effective light shielding against the adverse ray having the intermediate image height without providing light shielding against the on-axis ray at the position of the sub-stop.

In order to obtain more favorable characteristics, it is preferable to set the upper limit of Conditional Expression (9) to any of 4.5, 4, 3.5, 3, 2.5, 2.4, 2.3, 2.2, 2.1, 2, 1.9, 1.8, 1.7, 1.6, 1.5, 1.4, 1.3, 1.2, or 1.1 instead of 5. It is preferable to set the lower limit of Conditional Expression (9) to any of −4.5, −4, −3.5, −3, −2.5, −2.4, −2.3, −2.2, −2.1, −2, −1.9, −1.8, −1.7, or —1.6 instead of −5.

For example, in the optical system in FIG. 1, the lens L1 that is a single lens is one lens component and is the first lens component from the object side in the optical system in FIG. 1. A cemented lens in which the lens L2 and the lens L3 are cemented is also one lens component and is the second lens component from the object side in the optical system in FIG. 1. A cemented lens in which the lens L4 and the lens L5 are cemented is also one lens component and is the third lens component from the object side in the optical system in FIG. 1. The lens L6 that is a single lens is also one lens component and is the fourth lens component from the object side in the optical system in FIG. 1. The term “all lens components on the object side with respect to the sub-stop” means lens components, each of which is wholly positioned on the object side with respect to the sub-stop, and does not mean lens components, each of which is partially positioned on the object side with respect to the sub-stop. Thus, in a case where Conditional Expression (9) is considered for the sub-stop St2 in FIG. 1, the lens L6 is not a lens component on the object side with respect to the sub-stop St2 because a part of lens surfaces of the lens L6 is positioned in the opening of the sub-stop St2. All lens components on the object side with respect to the sub-stop St2 in the optical system in FIG. 1 are only three lens components including the first, second, and third lens components from the object side.

The sub-stop preferably moves in an integrated manner with at least one lens of the optical system during focusing or is fixed with respect to the image plane Sim in an integrated manner with at least one lens of the optical system during focusing. In a case where the optical system is the variable magnification optical system, the sub-stop preferably moves in an integrated manner with at least one lens of the optical system during changing the magnification or is fixed with respect to the image plane Sim in an integrated manner with at least one lens of the optical system during changing the magnification. Doing so eliminates need for providing a mechanism for moving the sub-stop separately from a mechanism for moving the lens and thus, can contribute to size reduction and suppress complication of the mechanical mechanism. In the present specification, the term “move in an integrated manner” means movement by the same amount in the same direction at the same time.

For example, in the optical system in FIG. 2, during focusing, the lenses L8 to L13 and the sub-stops St3 and St4 move in an integrated manner along the optical axis Z, and the lenses L1 to L7, the main stop FS, and the sub-stops St1 and St2 are fixed with respect to the image plane Sim in an integrated manner. The bracket and the leftward arrow below the lenses L8 to L13 and the sub-stops St3 and St4 in FIG. 2 indicate that these are the focus group that moves to the object side during focusing from an infinite distance object to a short range object.

The above preferable configurations and available configurations can be combined with each other in any manner and are preferably selectively adopted, as appropriate, in accordance with required specifications.

Next, examples of the optical system of the present disclosure will be described with reference to the drawings. Reference numerals provided to the lenses or the lens groups in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A cross-sectional view of a configuration and luminous fluxes of the optical system of Example 1 is illustrated in FIGS. 1 and 2, and its illustration method and its configuration are described above. Thus, duplicate descriptions will be partially omitted. The optical system of Example 1 comprises, in order from the object side to the image side, the lenses L1 to L13. The optical system of Example 1 comprises the main stop FS having a variable opening diameter, and the sub-stops St1 to St4 having fixed opening diameters.

For the optical system of Example 1, Table 1 shows basic lens data, Table 2 shows specifications, and Table 3 shows aspherical coefficients. The table of the basic lens data is described as follows. A column of Sn shows a surface number of each surface in a case where a surface closest to the object side is the first surface, and the number is increased by one for each subsequent surface. A column of R shows a curvature radius of each surface. A sign of the curvature radius of a surface having a convex shape facing the object side is positive, and a sign of the curvature radius of a surface having a convex shape facing the image side is negative. A column of D shows a surface spacing on the optical axis between each surface and a surface subsequent thereto. A sign of the surface spacing is positive for the spacing in a direction of the image side and is negative for the spacing in a direction of the object side. A value in the lowermost field of the column of D indicates a spacing between a surface closest to the image side in the table and the image plane Sim. A column of Nd shows a refractive index with respect to a d line for each constituent. A column of vd shows an Abbe number based on the d line for each constituent. The table of the basic lens data also shows the optical member PP.

In the table of the basic lens data, for the surface corresponding to the main stop FS, a field of the surface number shows the surface number and “(FS)”, and a field at the right of the surface spacing shows “main stop”. For the surface corresponding to the sub-stop St1, a field at the right of the surface spacing shows “sub-stop St1”, and its opening diameter is shown after “φ”. The same approach as the surface corresponding to the sub-stop St1 applies to the surfaces corresponding to the sub-stops St2 to St4.

Table 2 shows the focal length f, a back focus Bf as the air conversion distance, an open F-number FNo., a maximum full angle of view 2ω, the opening diameter φF of the main stop FS in the open state, and the total length TL of the optical system in a state where the infinite distance object is in focus, based on a d line. In a field of the maximum full angle of view, [°] indicates a degree unit.

In the basic lens data, a surface number of an aspherical surface is marked with *, and a field of the curvature radius of the aspherical surface shows a numerical value of a paraxial curvature radius. In Table 3, the column of Sn shows the surface number of the aspherical surface, and columns of KA and Am show numerical values of the aspherical coefficients for each aspherical surface. Here, m of Am is an integer greater than or equal to 3 and varies depending on the surface. For example, for the first surface of Example 1, m=3, 4, 5, . . . , 16 is established. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - K A \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter (mm) unit is used for lengths. However, since the optical system can also be proportionally enlarged or proportionally reduced to be used, other appropriate units can also be used. Each table below shows numerical values rounded to predetermined digits.

TABLE 1
Example 1

| Sn | R | D | Nd | vd |
|---|---|---|---|---|
| *1 | 50.9202 | 1.8721 | 1.58313 | 59.38 |
| *2 | 15.5929 | 11.1254 | | |
| 3 | −41.2861 | 1.1918 | 1.48749 | 70.44 |
| 4 | 28.6638 | 4.2247 | 2.00069 | 25.46 |
| 5 | 547.2491 | 4.5904 | | |
| 6 | ∞ | 1.2330 | Sub-Stop St1 φ20.20 | |
| 7 | −45.3239 | 2.1805 | 1.68893 | 31.07 |
| 8 | 68.3842 | 4.6317 | 1.69680 | 55.53 |
| 9 | −26.2063 | 1.1493 | | |
| 10 | −18.8555 | 0.9231 | 1.74077 | 27.79 |
| 11 | −317.6806 | −0.1970 | | |
| 12 | ∞ | 0.2970 | Sub-Stop St2 φ22.40 | |
| 13 | 83.7496 | 4.1391 | 1.95375 | 32.32 |
| 14 | −37.6767 | 3.5285 | | |
| 15 (FS) | ∞ | 6.8400 | | |
| 16 | 26.4192 | 8.7875 | 1.55032 | 75.50 |
| 17 | −20.4793 | 0.8968 | 1.78880 | 28.43 |
| 18 | 94.9622 | 0.6390 | | |
| 19 | ∞ | −0.5390 | Sub-Stop St3 φ20.80 | |
| 20 | 43.8350 | 5.9348 | 1.75500 | 52.32 |
| 21 | −19.0896 | 0.9112 | 1.85478 | 24.80 |
| 22 | 873.6132 | 0.0693 | | |
| 23 | ∞ | 0.0308 | Sub-Stop St4 φ21.40 | |
| 24 | 34.7161 | 4.2520 | 1.92286 | 18.90 |
| 25 | −55.7621 | 0.1000 | | |
| *26 | 12.8449 | 1.1053 | 1.80625 | 40.91 |
| *27 | 8.6197 | 16.5117 | | |
| 28 | ∞ | 2.8500 | 1.51680 | 64.20 |
| 29 | ∞ | 1.1000 | | |

TABLE 2
Example 1

| | |
|---|---|
| f | 18.20 |
| Bf | 19.49 |
| FNo. | 1.44 |
| 2ω [°] | 76.4 |
| φF | 23.07 |
| TL | 89.41 |

TABLE 3
Example 1

| Sn | 1 | 2 | 26 | 27 |
|---|---|---|---|---|
| KA | −3.5524107E+00 | −4.3839153E−01 | −8.7749470E−01 | −1.7564944E+00 |
| A3 | 0.0000000E+00 | 0.0000000E+00 | 0.0000000E+00 | 0.0000000E+00 |
| A4 | 1.4562563E−04 | 1.9987653E−04 | −2.9457203E−04 | 4.5987345E−05 |
| A5 | −1.5586134E−05 | −1.4237156E−05 | −3.0213717E−05 | −4.2734089E−05 |
| A6 | 5.2002049E−07 | 3.8653493E−08 | 8.8294930E−06 | 8.3923312E−06 |
| A7 | 4.4576460E−08 | 9.7639392E−08 | −6.3236083E−07 | −6.7249893E−07 |
| A8 | −7.2822532E−09 | 1.3127811E−10 | 6.6065017E−08 | 3.8700650E−08 |
| A9 | 2.3897513E−10 | −1.7402613E−09 | −1.8681912E−08 | −1.0369127E−09 |
| A10 | 2.0729060E−11 | 1.0104915E−10 | 2.8496418E−09 | −7.1101541E−10 |
| A11 | −4.2346876E−13 | 1.0980116E−11 | −2.1192026E−10 | 1.4318222E−10 |
| A12 | −2.6304469E−13 | −1.4408297E−12 | 5.7452181E−12 | −4.3454846E−12 |
| A13 | 2.7068251E−14 | 5.0098114E−14 | 1.3592773E−13 | −1.7638060E−12 |
| A14 | −1.2272789E−15 | 2.0411475E−16 | −3.2656663E−15 | 2.5353158E−13 |
| A15 | 2.8191990E−17 | −5.1685374E−17 | −6.9338244E−16 | −1.4072532E−14 |
| A16 | −2.6907030E−19 | 9.6690889E−19 | 2.5709964E−17 | 2.9452493E−16 |

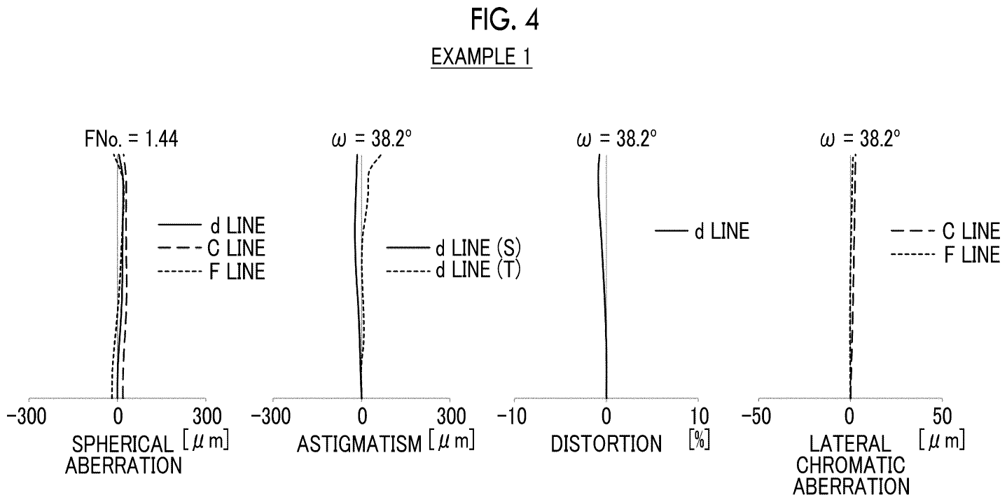

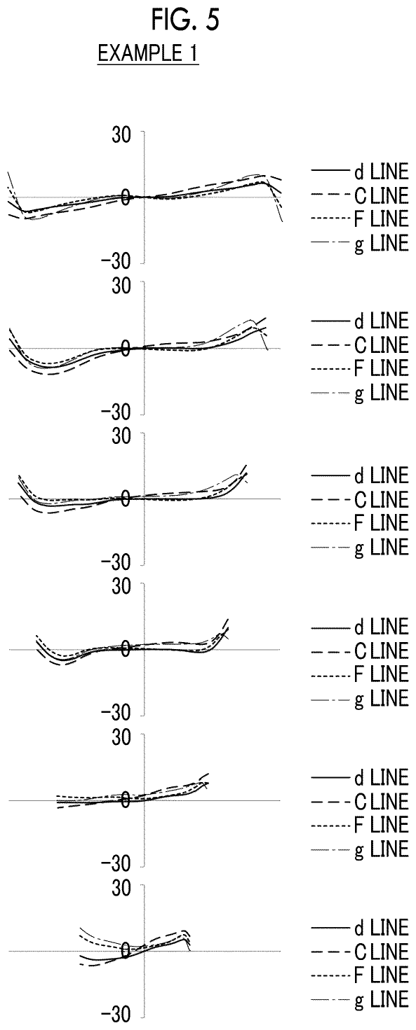

FIGS. 4 and 5 illustrate each aberration diagram of the optical system of Example 1 in the state where the infinite distance object is in focus. FIG. 4 illustrates, in order from the left, a spherical aberration, an astigmatism, a distortion, and a lateral chromatic aberration. In the spherical aberration diagram, the aberrations on a d line, a C line, and an F line are illustrated by a solid line, a long broken line, and a short broken line, respectively. In the astigmatism diagram, the aberration on the d line in a sagittal direction is illustrated by a solid line, and the aberration on the d line in a tangential direction is illustrated by a short broken line. In the distortion diagram, the aberration on the d line is illustrated by a solid line. In the lateral chromatic aberration diagram, the aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after “ω=”.

FIG. 5 illustrates, in order from the top, an axial lateral aberration (that is, at an image height of 0) and lateral aberrations at a 20% image height, a 40% image height, the 60% image height, an 80% image height, and the maximum image height. In FIG. 5, the aberrations on the d line, the C line, the F line, and the g line are illustrated by a solid line, a long broken line, a short broken line, and a dot-dashed line, respectively. The vertical axis in FIG. 5 is in micrometer (μm) units.

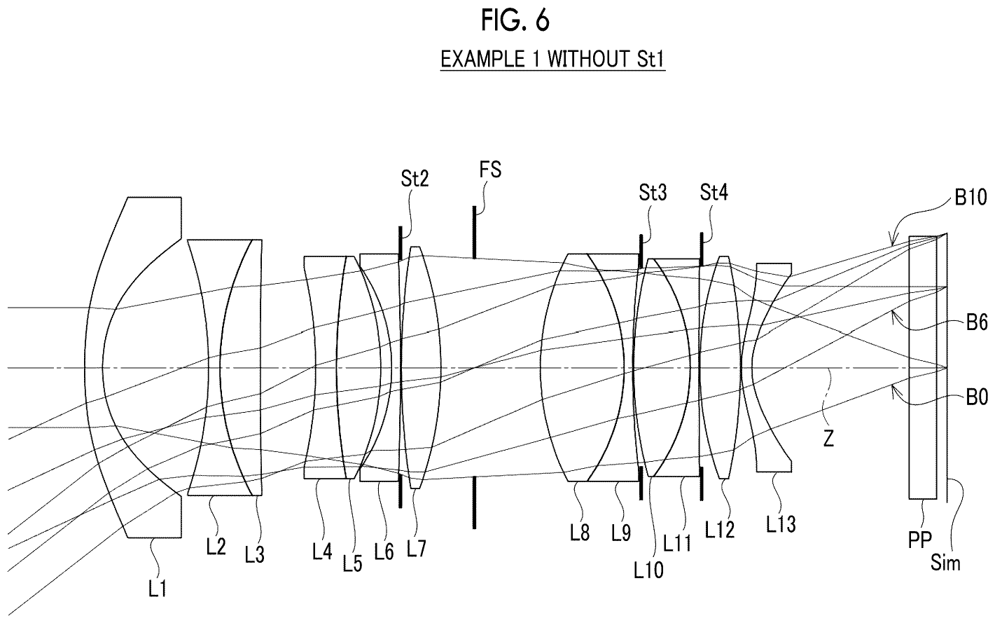

For comparison, FIG. 6 illustrates a cross-sectional view of a configuration and luminous fluxes in a case where the sub-stop St1 is removed from the optical system of Example 1. As the luminous fluxes, FIG. 6 illustrates the on-axis luminous flux B0, the luminous flux B6 having the 60% image height, and the luminous flux B10 having the maximum image height. In a case where FIG. 2 and FIG. 6 are compared with each other, the on-axis luminous flux BO and the luminous flux B10 having the maximum image height are the same, but a height of a lower ray of the luminous flux B6 having the 60% image height from the optical axis Z is different. More specifically, a location in which an absolute value of the height of the lower ray of the luminous flux B6 from the optical axis Z in FIG. 2 is smaller than that in FIG. 6 is found in a lens on the object side with respect to the main stop FS. That is, the sub-stop St1 provides light shielding against only a ray having the 60% image height without providing light shielding against the on-axis ray and the ray having the maximum image height, among the on-axis ray, the ray having the 60% image height, and the ray having the maximum image height.

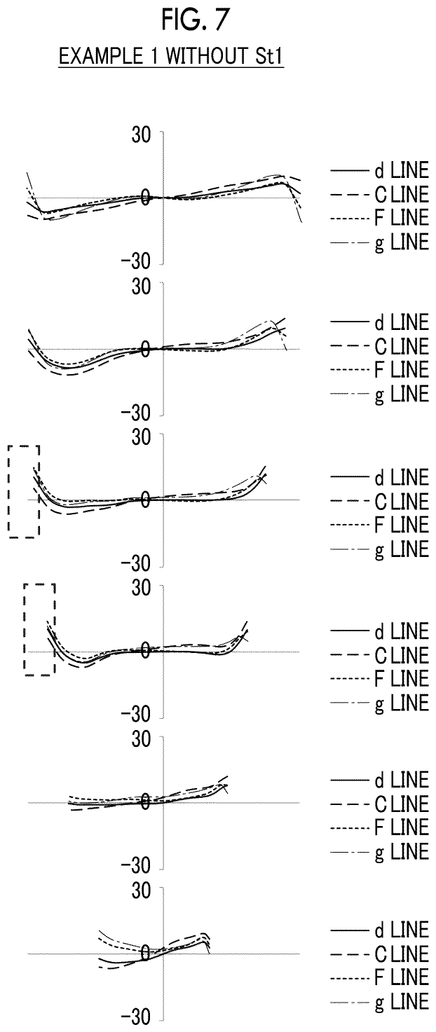

FIG. 7 illustrates lateral aberration diagrams of the optical system illustrated in FIG. 6. The illustration method and the unit of the vertical axis in FIG. 7 are the same as those in FIG. 5. FIG. 7 illustrates, in order from the top, the axial lateral aberration (that is, at the image height of 0) and lateral aberrations at the 20% image height, the 40% image height, the 60% image height, the 80% image height, and the maximum image height. In a case where FIG. 5 and FIG. 7 are compared with each other, the diagrams of the on-axis aberration and the maximum image height are the same, but the diagram of the intermediate image height is different. As a particularly noticeable difference, a part having a relatively large aberration amount in a region surrounded by an oblong shape of a broken line in FIG. 7 is not found in FIG. 5 in the diagrams of the 40% image height and the 60% image height. From this point, it is understood that the sub-stop St1 provides effective light shielding against the lower rays having the 40% image height and the 60% image height that cause the coma flare or the like, without providing light shielding against the on-axis luminous flux B0 and the luminous flux B10 having the maximum image height. That is, it is understood that the sub-stop St1 improves the image forming performance at the intermediate image height without decreasing the light quantity in the edge part of the image.

### Example 2

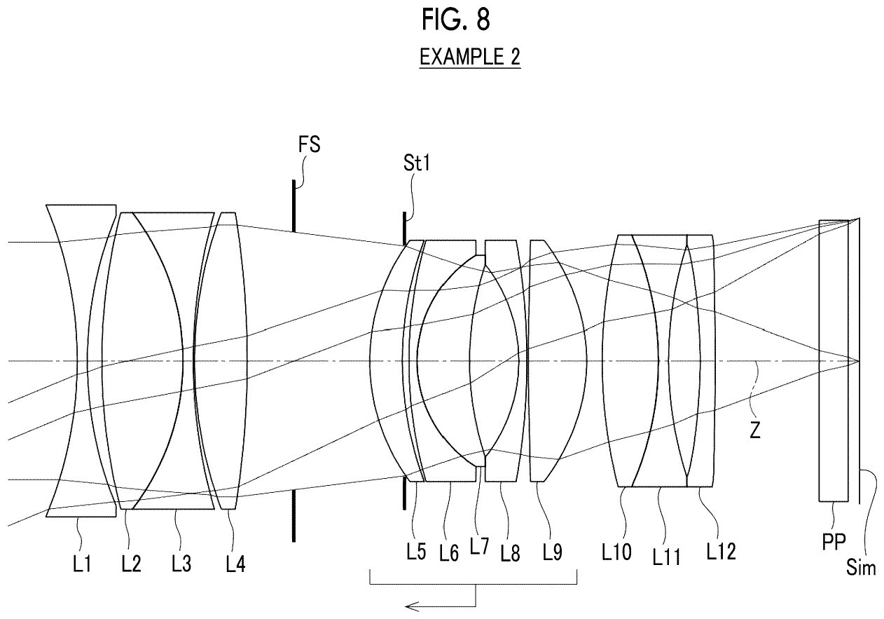

FIG. 8 illustrates a cross-sectional view of a configuration and luminous fluxes of an optical system of Example 2. The optical system of Example 2 comprises, in order from the object side to the image side, the lenses L1 to L12. The optical system of Example 2 comprises the main stop FS having a variable opening diameter, and the sub-stop St1 having a fixed opening diameter. The main stop FS functions as the stop for determining the F-number. The main stop FS is disposed between the lens L4 and the lens L5. The sub-stop St1 is disposed to include a surface of the lens L5 on the object side in its opening. During focusing from the infinite distance object to the short range object, the lenses L5 to L9 and the sub-stop St1 move to the object side in an integrated manner along the optical axis Z, and the lenses L1 to L4, the lenses L10 to L12, and the main stop FS are fixed with respect to the image plane Sim.

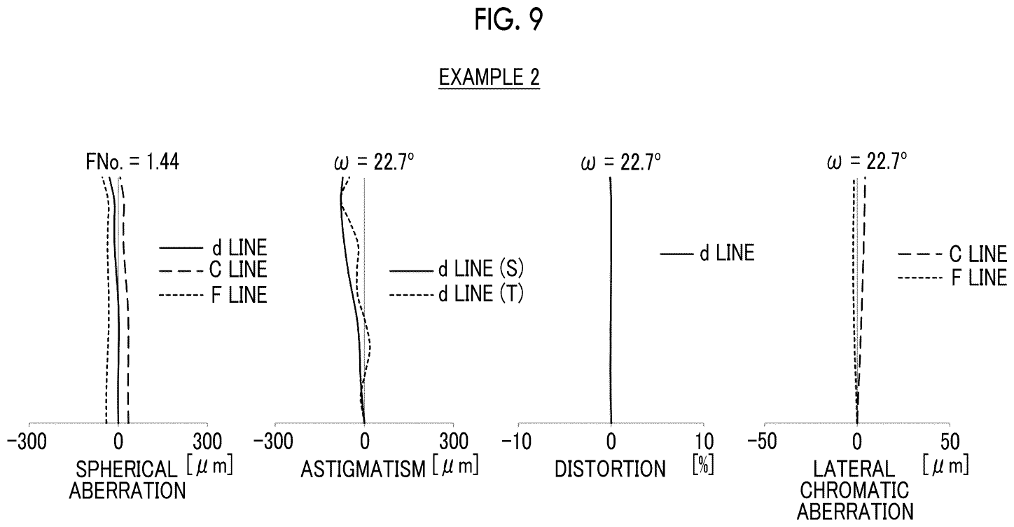

For the optical system of Example 2, Table 4 shows basic lens data, Table 5 shows specifications, Table 6 shows aspherical coefficients, and FIG. 9 illustrates each aberration diagram in the state where the infinite distance object is in focus. The illustration method of FIG. 9 is the same as that of FIG. 4 of Example 1. Other symbols, meanings, description methods, and illustration methods of each data of Example 2 are also the same as those of Example 1. Symbols, meanings, description methods, and illustration methods of each data of Examples 3 and later are also basically the same unless otherwise specified. Thus, duplicate descriptions will be omitted below.

TABLE 4
Example 2

| Sn | R | D | Nd | vd |
|---|---|---|---|---|
| 1 | −40.3834 | 0.9998 | 1.48749 | 70.44 |
| 2 | 38.0997 | 1.4257 | | |
| 3 | 59.0655 | 7.9999 | 1.69680 | 55.53 |
| 4 | −24.2746 | 1.0100 | 1.62004 | 36.26 |
| 5 | 53.1211 | 0.1298 | | |
| 6 | 42.5413 | 5.1853 | 1.83481 | 42.74 |
| 7 | −93.3590 | 4.5879 | | |
| 8 | ∞ | 11.0942 | | |
| (FS) | | | | |
| 9 | ∞ | −3.5970 | Sub-Stop St1 φ23.00 | |
| 10 | 20.1819 | 3.2144 | 1.95906 | 17.47 |
| 11 | 34.5549 | 0.6457 | | |
| 12 | 43.6796 | 0.7998 | 1.84666 | 23.78 |
| 13 | 12.5000 | 5.1200 | 1.59282 | 68.62 |
| 14 | 30.4714 | 4.8427 | | |
| 15 | −15.4860 | 0.8000 | 1.75211 | 25.05 |
| 16 | −68.4170 | 0.1298 | | |
| *17 | 159.8143 | 5.7629 | 1.85135 | 40.10 |
| *18 | −17.9951 | 1.5311 | | |
| 19 | 50.6459 | 5.5320 | 1.91082 | 35.25 |
| 20 | −31.0436 | 1.0098 | 1.73037 | 32.23 |
| 21 | 37.8861 | 3.1144 | | |
| *22 | −50.1906 | 1.5002 | 1.68948 | 31.02 |
| *23 | −148.8957 | 10.2560 | | |
| 24 | ∞ | 2.8500 | 1.51680 | 64.20 |
| 25 | ∞ | 1.1000 | | |

TABLE 5
Example 2

| | |
|---|---|
| f | 34.01 |
| Bf | 13.24 |
| FNo. | 1.44 |
| 2ω [°] | 45.4 |
| φF | 25.61 |
| TL | 76.07 |

TABLE 6
Example 2

| Sn | 17 | 18 | 22 | 23 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −6.7892977E−06 | 2.6728027E−05 | 2.0699818E−05 | −2.6025700E−05 |
| A5 | −3.4998037E−06 | −3.1585103E−06 | −3.5609821E−06 | 2.0701497E−05 |
| A6 | 2.6708753E−07 | 3.6167193E−08 | 1.0411116E−06 | −3.2441813E−06 |
| A7 | 4.1719229E−08 | 5.7847224E−08 | −4.6385997E−08 | 2.0830649E−07 |
| A8 | −4.6906387E−09 | −3.6372615E−09 | −1.0004409E−08 | 8.0249345E−09 |
| A9 | −2.1393790E−10 | −3.2271859E−10 | 6.1558719E−10 | −2.2013977E−09 |
| A10 | 3.2807144E−11 | 2.9770156E−11 | 2.8180923E−11 | 7.4088106E−11 |
| A11 | 3.7083422E−13 | 6.2009046E−13 | −1.8453397E−12 | 4.8533222E−12 |
| A12 | −7.9543983E−14 | −7.1537115E−14 | −2.8600819E−14 | −2.7168254E−13 |

### Example 3

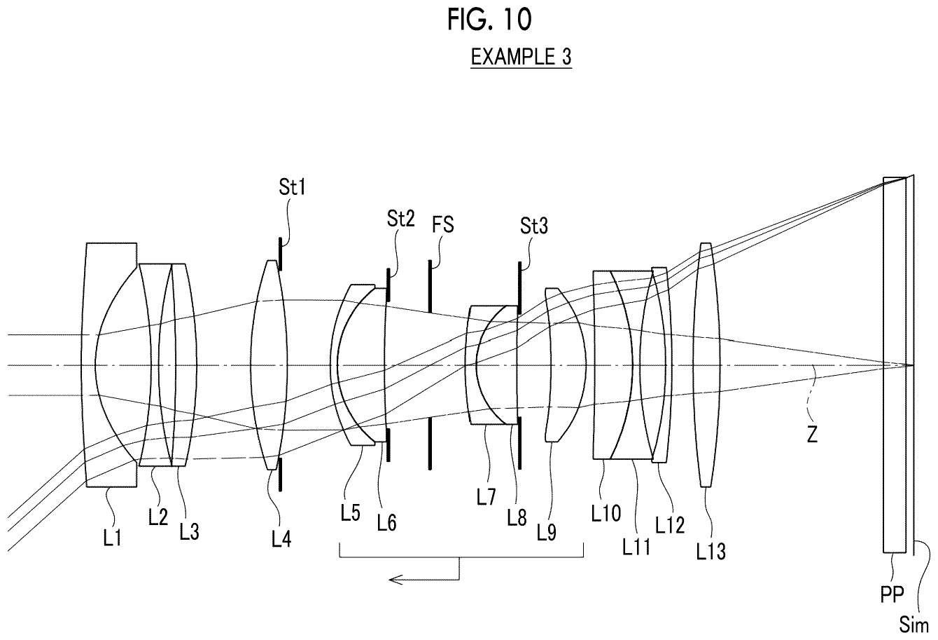

FIG. 10 illustrates a cross-sectional view of a configuration and luminous fluxes of an optical system of Example 3. The optical system of Example 3 comprises, in order from the object side to the image side, the lenses L1 to L13. The optical system of Example 3 comprises the main stop FS having a variable opening diameter, and the sub-stops St1 to St3 having fixed opening diameters. The main stop FS functions as the stop for determining the F-number. The main stop FS is disposed between the lens L6 and the lens L7. The sub-stop St1 is disposed to include a surface of the lens L4 on the image side in its opening. The sub-stop St2 is disposed adjacent to the image side with respect to the surface of the lens L6 on the image side. The sub-stop St3 is disposed adjacent to the image side with respect to a surface of the lens L8 on the image side. During focusing from the infinite distance object to the short range object, the lenses L5 to L9, the main stop FS, and the sub-stops St2 and St3 move to the object side in an integrated manner along the optical axis Z, and the lenses L1 to L4, the lenses L10 to L13, and the sub-stop St1 are fixed with respect to the image plane Sim.

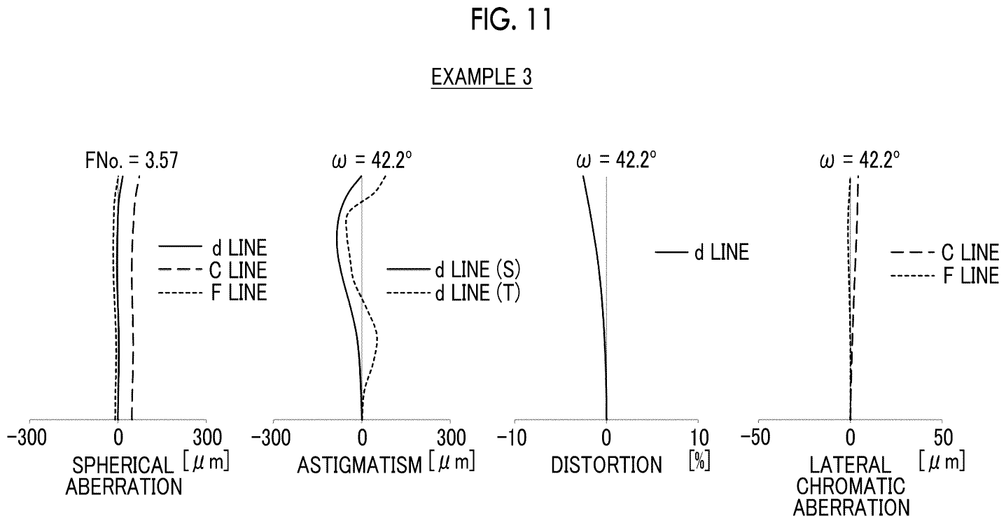

For the optical system of Example 3, Table 7 shows basic lens data, Table 8 shows specifications, Table 9 shows aspherical coefficients, and FIG. 11 illustrates each aberration diagram in the state where the infinite distance object is in focus.

TABLE 7
Example 3

| Sn | R | D | Nd | vd |
|---|---|---|---|---|
| *1 | 147.3129 | 2.0000 | 1.80999 | 41.01 |
| *2 | 17.3859 | 7.9700 | | |
| 3 | −61.0298 | 1.0500 | 1.49700 | 81.61 |
| 4 | 55.9990 | 2.4440 | | |
| 5 | −175.2376 | 2.9940 | 1.71736 | 29.52 |
| 6 | −64.6749 | 7.6770 | | |
| 7 | 47.9629 | 5.2330 | 1.72000 | 43.69 |
| 8 | −71.4295 | −1.2870 | | |
| 9 | ∞ | 7.4130 | Sub-Stop St1 φ27.00 | |
| 10 | 24.0087 | 1.0000 | 1.80165 | 44.27 |
| 11 | 14.0015 | 6.7130 | 1.60042 | 61.94 |
| 12 | 156.4580 | 0.2886 | | |
| 13 | ∞ | 6.2244 | Sub-Stop St2 φ18.00 | |
| 14 | ∞ | 4.9880 | | |
| (FS) | | | | |
| 15 | 48.1421 | 1.5000 | 1.91082 | 35.25 |
| 16 | 10.5912 | 5.7900 | 1.56907 | 71.31 |
| 17 | 346.0071 | 0.0925 | | |
| 18 | ∞ | 4.7605 | Sub-Stop St3 φ14.60 | |
| *19 | −84.0231 | 5.0000 | 1.58913 | 61.15 |
| *20 | −18.0076 | 1.2320 | | |
| 21 | −356.4668 | 5.4070 | 2.00272 | 19.32 |
| 22 | −30.0142 | 1.0260 | 1.73800 | 32.33 |
| 23 | 48.3922 | 3.6720 | | |
| 24 | −48.1026 | 0.9000 | 1.98613 | 16.48 |
| 25 | −122.1059 | 3.0200 | | |
| 26 | 137.7953 | 3.8420 | 1.63545 | 59.73 |
| 27 | −115.9825 | 23.3120 | | |
| 28 | ∞ | 3.2000 | 1.51680 | 64.20 |
| 29 | ∞ | 1.1000 | | |

TABLE 8
Example 3

| | |
|---|---|
| f | 30.91 |
| Bf | 26.52 |
| FNo. | 3.57 |
| 2ω [°] | 84.4 |
| φF | 14.96 |
| TL | 117.47 |

TABLE 9
Example 3

| Sn | 1 | 2 | 19 | 20 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.7190323E−06 | −1.0324755E−05 | −3.6874743E−05 | −1.7507432E−05 |
| A5 | −7.4474335E−07 | −9.9518618E−07 | 1.5262016E−06 | 1.8963888E−06 |
| A6 | 3.0051321E−08 | −6.4950083E−09 | 2.2784479E−07 | −1.6630172E−07 |
| A7 | 8.1417469E−12 | 1.0528595E−09 | −9.8209300E−08 | −4.0718008E−08 |
| A8 | 2.6419440E−11 | −1.9802457E−10 | 4.2866430E−10 | 3.0729611E−09 |
| A9 | −8.4613032E−13 | 9.3801528E−12 | 1.4337539E−09 | 2.2019263E−10 |
| A10 | −6.7674963E−14 | −2.6840622E−14 | 4.1053517E−11 | −1.0135846E−11 |
| A11 | −5.2825214E−15 | −9.6141003E−14 | −1.4808362E−11 | −1.3635971E−12 |
| A12 | 1.3685955E−17 | 9.2320265E−15 | −7.4799199E−13 | 3.6925212E−14 |
| A13 | −2.1817230E−17 | −9.7218804E−16 | 9.9226988E−14 | −2.6847120E−14 |
| A14 | 1.9880799E−18 | 3.3672325E−17 | 2.1856025E−15 | 1.3212027E−15 |
| A15 | 7.8661839E−20 | 4.2370872E−18 | 2.2178857E−16 | 1.8274698E−16 |
| A16 | 9.0261546E−21 | −9.1536371E−19 | −2.2420853E−16 | 3.5944816E−17 |
| A17 | −5.4358767E−22 | 7.0329374E−20 | 3.2929455E−17 | −3.1433068E−18 |
| A18 | −4.4806487E−23 | −3.5736344E−22 | 2.2161945E−19 | −6.0753510E−19 |
| A19 | 2.0403062E−24 | −1.5453784E−22 | −2.7567893E−19 | 6.0854810E−20 |
| A20 | −5.5439226E−27 | 3.7714093E−24 | 1.1764954E−20 | −9.4474266E−22 |

### Example 4

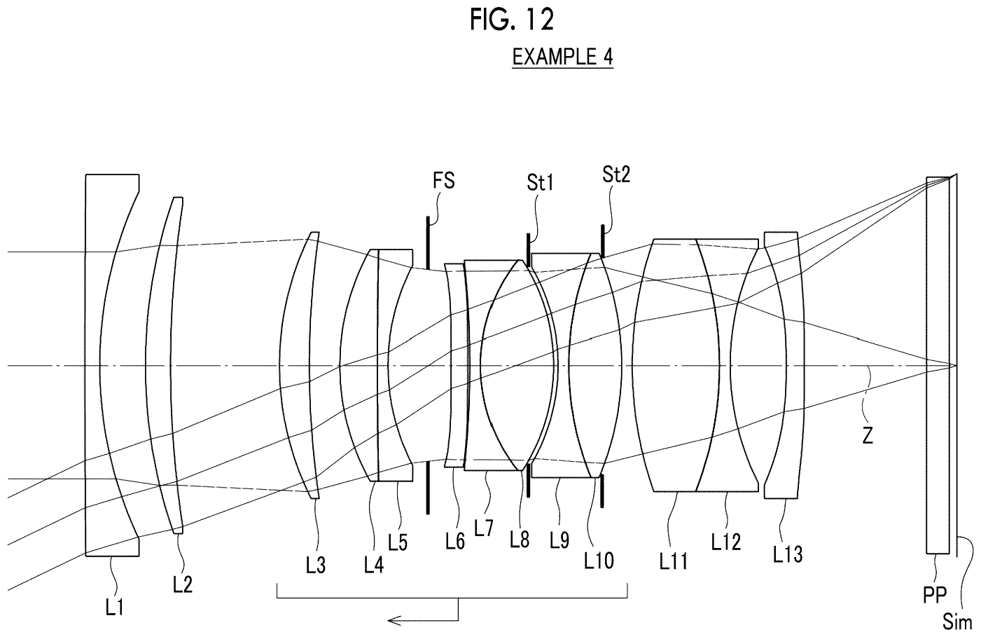

FIG. 12 illustrates a cross-sectional view of a configuration and luminous fluxes of an optical system of Example 4. The optical system of Example 4 comprises, in order from the object side to the image side, the lenses L1 to L13. The optical system of Example 4 comprises the main stop FS having a variable opening diameter, and the sub-stops St1 and St2 having fixed opening diameters. The main stop FS functions as the stop for determining the F-number. The main stop FS is disposed between the lens L5 and the lens L6. The sub-stop St1 is disposed to include the surface of the lens L8 on the image side in its opening. The sub-stop St2 is disposed to include a surface of the lens L10 on the image side in its opening. During focusing, the lenses L3 to L10, the main stop FS, and the sub-stops St1 and St2 move to the object side in an integrated manner along the optical axis Z, and the lenses L1 and L2 and the lenses L11 to L13 are fixed with respect to the image plane Sim.

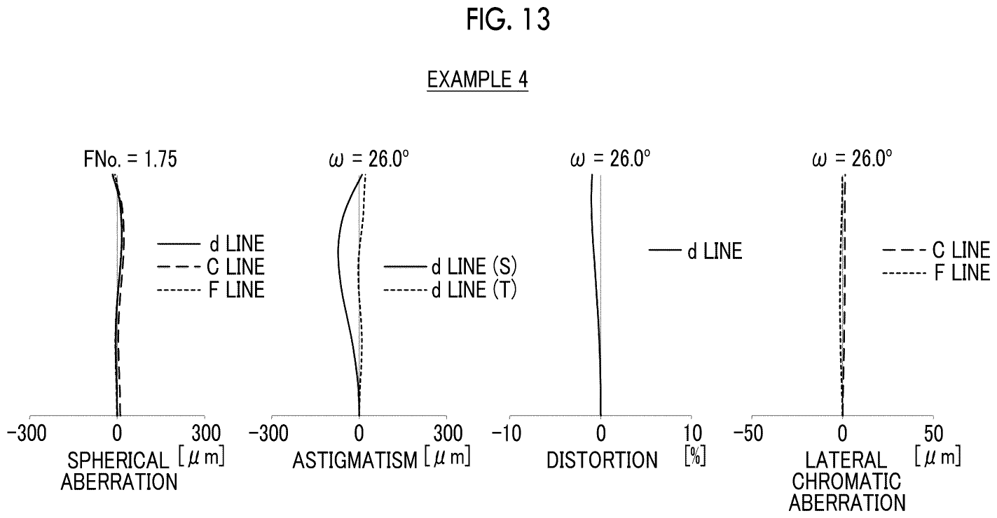

For the optical system of Example 4, Table 10 shows basic lens data, Table 11 shows specifications, Table 12 shows aspherical coefficients, and FIG. 13 illustrates each aberration diagram in the state where the infinite distance object is in focus.

TABLE 10
Example 4

| Sn | R | D | Nd | vd |
|---|---|---|---|---|
| 1 | 3395.1569 | 2.1000 | 1.51742 | 52.15 |
| 2 | 58.1682 | 6.4667 | | |
| 3 | 74.0322 | 3.5505 | 1.77535 | 50.30 |
| 4 | 153.3942 | 15.4200 | | |
| 5 | 42.4814 | 4.2313 | 2.00069 | 25.46 |
| 6 | 130.7358 | 4.3112 | | |
| 7 | 33.8928 | 5.3234 | 1.49700 | 81.61 |
| 8 | 848.1439 | 1.5000 | 1.84666 | 23.78 |
| 9 | 30.8686 | 5.6532 | | |
| 10 | ∞ | 3.2952 | | |
| (FS) | | | | |
| *11 | −1998.5918 | 2.3248 | 1.80225 | 45.45 |
| *12 | −34995.5964 | 0.3024 | | |
| 13 | −142.3892 | 1.5000 | 1.59270 | 35.45 |
| 14 | 24.1595 | 10.2742 | 1.55032 | 75.50 |
| 15 | −27.6669 | −3.8036 | | |
| 16 | ∞ | 4.4341 | Sub-Stop St1 φ28.00 | |
| 17 | −28.0490 | 1.5200 | 1.77047 | 29.74 |
| 18 | 42.2219 | 7.4809 | 1.90200 | 25.26 |
| 19 | −41.4373 | −3.0080 | | |
| 20 | ∞ | 4.5080 | Sub-Stop St2 φ31.00 | |
| 21 | 54.6186 | 12.3453 | 1.84850 | 43.79 |
| 22 | −49.7007 | 1.5200 | 1.59551 | 39.22 |
| 23 | 37.3059 | 7.9438 | | |
| *24 | −76.8164 | 2.5455 | 1.68948 | 31.02 |
| *25 | −1406.3294 | 17.2924 | | |
| 26 | ∞ | 3.2000 | 1.51680 | 64.20 |
| 27 | ∞ | 1.1000 | | |

TABLE 11
Example 4

| | |
|---|---|
| f | 56.67 |
| Bf | 20.50 |
| FNo. | 1.75 |
| 2ω [°] | 52.0 |
| φF | 27.29 |
| TL | 122.24 |

TABLE 12
Example 4

| Sn | 11 | 12 | 24 | 25 |
|---|---|---|---|---|
| KA | 1.0000000E+00 | 1.0000000E+00 | 1.0000000E+00 | 1.0000000E+00 |
| A4 | −2.0370108E−05 | −1.4890456E−05 | −2.5350781E−05 | −2.0566239E−05 |
| A6 | −2.2837244E−08 | −1.4092898E−08 | 5.0780164E−08 | 5.3699159E−08 |
| A8 | 1.5881928E−10 | 1.4530204E−10 | −5.4993528E−11 | −5.6857976E−11 |
| A10 | −2.7238168E−13 | −2.5033093E−13 | 4.3033371E−14 | 4.1725261E−14 |

### Example 5

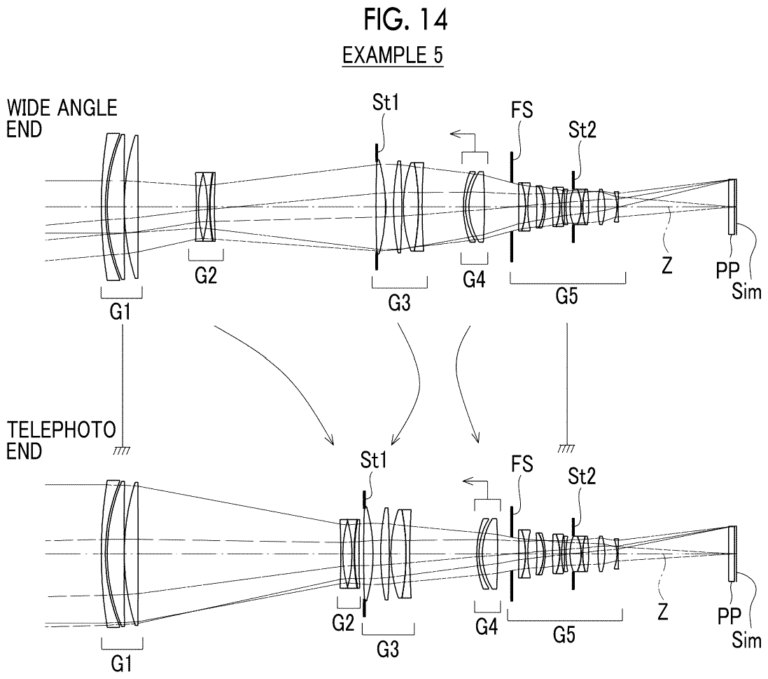

FIG. 14 illustrates a cross-sectional view of a configuration and luminous fluxes of an optical system of Example 5. The optical system of Example 5 is a zoom lens. In FIG. 14, an upper part labeled “WIDE ANGLE END” shows a wide angle end state, and a lower part labeled “TELEPHOTO END” shows a telephoto end state. The optical system of Example 5 consists of, in order from the object side to the image side, a first lens group G1, a second lens group G2, a third lens group G3, a fourth lens group G4, and a fifth lens group G5. During changing the magnification, the second lens group G2, the third lens group G3, and the fourth lens group G4 move along the optical axis Z by changing spacings with respect to adjacent lens groups, and the first lens group G1 and the fifth lens group G5 are fixed with respect to the image plane Sim. Between the upper part and the lower part of FIG. 14, an arrow shows a schematic moving path during changing the magnification from the wide angle end to the telephoto end for a lens group that moves during changing the magnification, and a ground symbol shows a lens group that is fixed during changing the magnification.

The optical system of Example 5 comprises the main stop FS having a variable opening diameter, and the sub-stops St1 and St2 having fixed opening diameters. The main stop FS functions as the stop for determining the F-number. The main stop FS is disposed closest to the object side in the fifth lens group G5. The sub-stop St1 is disposed to include a surface, on the object side, of a lens closest to the object side in the third lens group G3 in its opening. The sub-stop St2 is disposed to include a surface, on the object side, of the fifth lens from the image side in the fifth lens group G5 in its opening. The sub-stop St1 and the sub-stop St2 provide light shielding against the adverse ray having the intermediate image height at the wide angle end.

During changing the magnification, the sub-stop St1 moves in an integrated manner with the lens of the third lens group G3 along the optical axis Z, and the main stop FS and the sub-stop St2 are fixed with respect to the image plane Sim in an integrated manner with the lens of the fifth lens group G5. The focus group consists of the fourth lens group G4. The bracket and the leftward arrow above the fourth lens group G4 in FIG. 14 indicate that the fourth lens group G4 is the focus group that moves to the object side during focusing from the infinite distance object to the short range object. During focusing, lenses of the lens groups other than the fourth lens group G4, the main stop FS, and the sub-stops St1 and St2 are fixed with respect to the image plane Sim in an integrated manner.

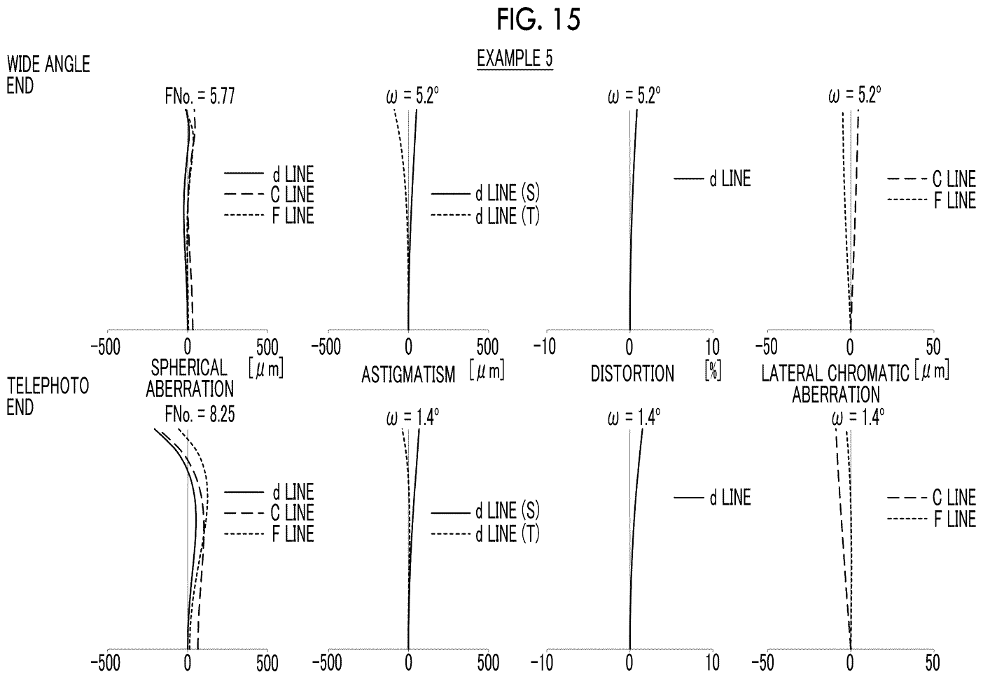

Table 13 shows basic lens data of the optical system of Example 5. In the table of the basic lens data, a symbol DD[] is used for a variable surface spacing during changing the magnification, and the surface number of this spacing on the object side is shown in the column of the surface spacing in []. Table 14 shows specifications of the optical system of Example 5 and the variable surface spacing. In Table 14, a column labeled “Wide Angle End” shows each value in the wide angle end state, and a column labeled “Telephoto End” shows each value in the telephoto end state. Table 14 also shows a zoom magnification. FIG. 15 shows each aberration diagram of the optical system of Example 5 in the state where the infinite distance object is in focus. In FIG. 15, an upper part labeled “WIDE ANGLE END” shows the aberrations in the wide angle end state, and a lower part labeled “TELEPHOTO END” shows the aberrations in the telephoto end state.

TABLE 13
Example 5

| Sn | R | D | Nd | vd |
|---|---|---|---|---|
| 1 | 239.6856 | 2.0220 | 1.62005 | 36.35 |
| 2 | 97.7152 | 1.0000 | | |
| 3 | 97.9386 | 8.4970 | 1.49782 | 82.57 |
| 4 | 3190.4357 | 0.1000 | | |
| 5 | 124.1719 | 6.9960 | 1.49782 | 82.57 |
| 6 | −6005.5001 | DD[6] | | |
| 7 | −403.9950 | 1.0650 | 1.65100 | 56.24 |
| 8 | 62.7965 | 4.5770 | | |
| 9 | −65.8393 | 1.0650 | 1.49782 | 82.57 |
| 10 | 105.0123 | 0.2900 | | |
| 11 | 101.2552 | 2.1910 | 1.89286 | 20.36 |
| 12 | 407.8006 | DD[12] | | |
| 13 | ∞ | −0.4043 | Sub-Stop St1 φ46.00 | |
| 14 | 654.4160 | 4.7770 | 1.49700 | 81.54 |
| 15 | −91.2918 | 3.8740 | | |
| 16 | 123.4704 | 4.1050 | 1.49700 | 81.54 |
| 17 | −420.2358 | 0.8200 | | |
| 18 | 69.1599 | 7.6260 | 1.41390 | 100.82 |
| 19 | −121.4092 | 1.8990 | 1.89190 | 37.13 |
| 20 | 365.5704 | DD[20] | | |
| 21 | 50.5957 | 1.1270 | 1.83481 | 42.74 |
| 22 | 33.9895 | 1.7140 | | |
| 23 | 34.4355 | 7.7690 | 1.49700 | 81.54 |
| 24 | −297.7891 | DD[24] | | |
| 25 | ∞ | 3.5350 | | |
| (FS) | | | | |
| 26 | −565.8282 | 3.3950 | 1.73800 | 32.33 |
| 27 | −39.5491 | 1.1310 | 1.69680 | 55.53 |
| 28 | 53.0227 | 4.6260 | | |
| 29 | −142.0862 | 3.3950 | 1.54072 | 47.23 |
| 30 | −23.2563 | 0.8610 | 2.00069 | 25.46 |
| 31 | −32.4632 | 3.6650 | | |
| 32 | 179.1180 | 3.6490 | 1.80518 | 25.42 |
| 33 | −28.1744 | 0.9310 | 1.72916 | 54.68 |
| 34 | 50.2096 | 1.4240 | | |
| 35 | −175.6520 | 0.7510 | 1.81600 | 46.54 |
| 36 | 43.2903 | 3.5280 | | |
| 37 | ∞ | −1.4700 | Sub-Stop St2 φ17.00 | |
| 38 | 25.3065 | 5.6690 | 1.67300 | 38.26 |
| 39 | −21.5228 | 0.8010 | 2.00069 | 25.46 |
| 40 | 33.8212 | 2.9860 | 1.73800 | 32.33 |
| 41 | −61.4492 | 4.7290 | | |
| 42 | 50.7456 | 3.4190 | 1.62004 | 36.26 |
| 43 | −31.1375 | 6.1240 | | |
| 44 | −20.7699 | 0.6000 | 1.77250 | 49.60 |
| 45 | 124.3463 | 55.8798 | | |
| 46 | ∞ | 2.8500 | 1.51680 | 64.20 |
| 47 | ∞ | 1.1000 | | |

TABLE 14
Example 5

| | Wide Angle End | Telephoto End |
|---|---|---|
| Zoom | 1.0 | 3.8 |
| Magnification | | |
| f | 154.65 | 583.13 |
| Bf | 58.83 | 58.83 |
| FNo. | 5.77 | 8.25 |
| 2ω [°] | 10.4 | 2.8 |
| φF | 24.74 | 17.04 |
| TL | 319.87 | 319.87 |
| DD[6] | 29.41 | 102.48 |
| DD[12] | 82.07 | 2.74 |
| DD[20] | 20.83 | 33.85 |
| DD[24 | 13.87 | 7.12 |

### Example 6

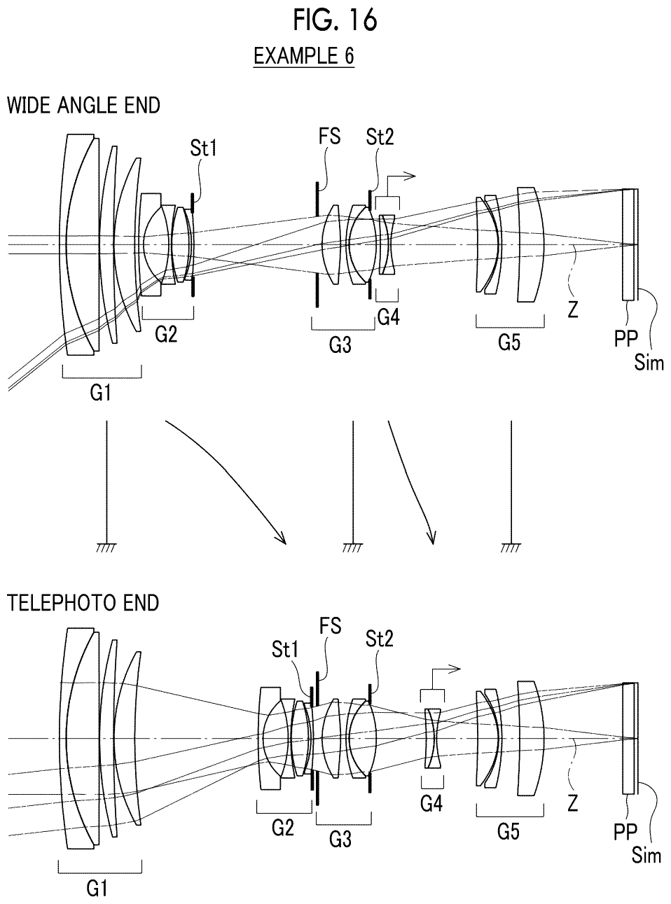

FIG. 16 illustrates a cross-sectional view of a configuration and luminous fluxes of an optical system of Example 6. The optical system of Example 6 is a zoom lens. A description method and an illustration method of data of the optical system of Example 6 are basically the same as those of Example 5. Thus, duplicate descriptions will be partially omitted. The optical system of Example 6 consists of, in order from the object side to the image side, the first lens group G1, the second lens group G2, the third lens group G3, the fourth lens group G4, and the fifth lens group G5. During changing the magnification, the second lens group G2 and the fourth lens group G4 move along the optical axis Z, and the first lens group G1, the third lens group G3, and the fifth lens group G5 are fixed with respect to the image plane Sim.

The optical system of Example 6 comprises the main stop FS having a variable opening diameter, and the sub-stops St1 and St2 having fixed opening diameters. The main stop FS functions as the stop for determining the F-number. The main stop FS is disposed closest to the object side in the third lens group G3. The sub-stop St1 is disposed to include a surface, on the image side, of a lens closest to the image side in the second lens group G2 in its opening. The sub-stop St2 is disposed to include a surface, on the image side, of a lens closest to the image side in the third lens group G3 in its opening. The sub-stop St1 and the sub-stop St2 provide light shielding against the adverse ray having the intermediate image height at the telephoto end.

During changing the magnification, the sub-stop St1 moves in an integrated manner with the lens of the second lens group G2 along the optical axis Z, and the main stop FS and the sub-stop St2 are fixed with respect to the image plane Sim in an integrated manner with the lens of the third lens group G3. The focus group consists of the fourth lens group G4. The bracket and the rightward arrow above the fourth lens group G4 in FIG. 16 indicate that the fourth lens group G4 is the focus group that moves to the image side during focusing from the infinite distance object to the short range object. During focusing, lenses of the lens groups other than the fourth lens group G4, the main stop FS, and the sub-stops St1 and St2 are fixed with respect to the image plane Sim in an integrated manner.

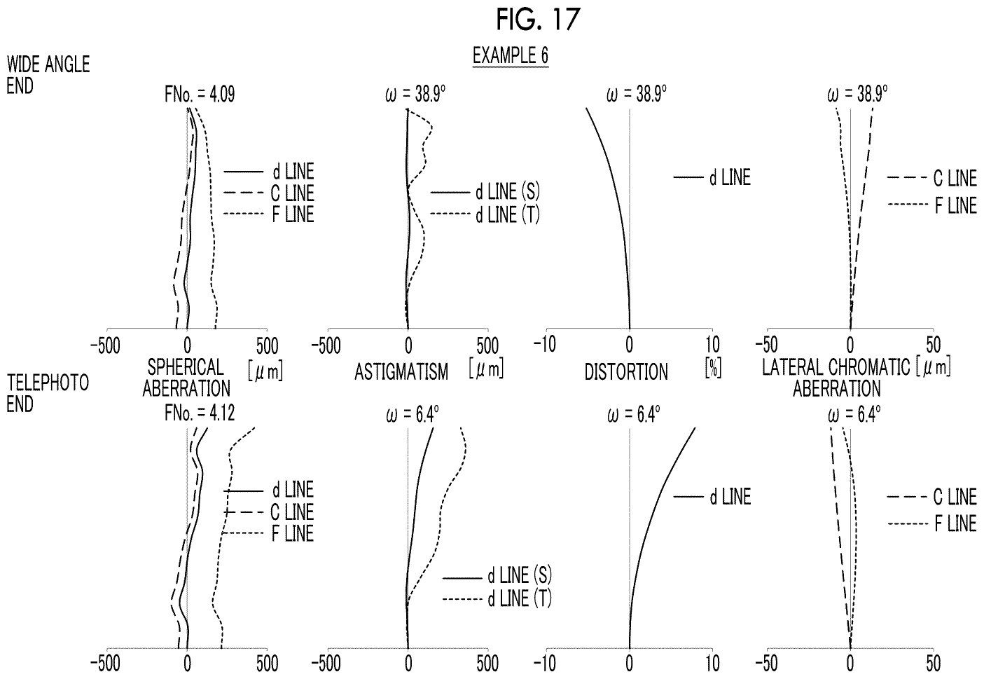

For the optical system of Example 6, Table 15 shows basic lens data, Table 16 shows specifications and a variable surface spacing, Table 17 shows aspherical coefficients, and FIG. 17 illustrates each aberration diagram in the state where the infinite distance object is in focus.

TABLE 15
Example 6

| Sn | R | D | Nd | vd |
|---|---|---|---|---|
| 1 | 192.9221 | 1.7000 | 1.85000 | 27.03 |
| 2 | 55.8776 | 8.2750 | 1.53775 | 74.70 |
| 3 | −19857.1205 | 0.1200 | | |
| 4 | 97.4892 | 3.5130 | 1.59283 | 68.63 |
| 5 | 357.3671 | 0.1190 | | |
| 6 | 45.9156 | 5.2120 | 1.79828 | 48.27 |
| 7 | 158.1434 | DD[7] | | |
| *8 | 220.9427 | 1.2000 | 1.80610 | 40.73 |
| *9 | 12.9080 | 6.3380 | | |
| 10 | −27.0447 | 0.6490 | 1.77535 | 50.30 |
| 11 | 49.1182 | 0.1190 | | |
| 12 | 31.0232 | 4.3170 | 1.84666 | 23.78 |
| 13 | −31.0232 | 0.6340 | | |
| 14 | −22.6511 | 0.6000 | 1.88300 | 40.85 |
| 15 | −83.3290 | −0.3801 | | |
| 16 | ∞ | DD[16] | Sub-Stop St1 φ15.90 | |
| 17 | ∞ | 1.2000 | | |
| (FS) | | | | |
| *18 | 18.2045 | 4.4890 | 1.48789 | 83.67 |
| *19 | −47.7735 | 1.3660 | | |
| 20 | 29.9722 | 0.8010 | 1.91082 | 35.25 |
| 21 | 13.0000 | 6.8240 | 1.53775 | 74.70 |
| 22 | −23.7988 | −1.6276 | | |
| 23 | ∞ | DD[23] | Sub-Stop St2 φ17.30 | |
| 24 | −75.5025 | 2.0150 | 1.89502 | 25.23 |
| 25 | −18.7696 | 0.6100 | 1.76963 | 51.04 |
| 26 | 23.6824 | DD[26] | | |
| *27 | −178.4122 | 5.1550 | 1.58313 | 59.46 |
| *28 | −16.6219 | 0.1200 | | |
| 29 | −20.4508 | 0.8100 | 2.00272 | 19.32 |
| 30 | −52.2877 | 4.4750 | | |
| 31 | −199.2175 | 6.1240 | 1.72073 | 29.78 |
| 32 | −43.1534 | 19.6773 | | |
| 33 | ∞ | 2.8500 | 1.51680 | 64.20 |
| 34 | ∞ | 1.1000 | | |

TABLE 16
Example 6

| | Wide Angle End | Telephoto End |
|---|---|---|
| Zoom | 1.0 | 6.3 |
| Magnification | | |
| f | 18.54 | 116.77 |
| Bf | 22.66 | 22.66 |
| FNo. | 4.09 | 4.12 |
| 2ω [°] | 77.8 | 12.8 |
| φF | 14.33 | 16.51 |
| TL | 144.32 | 144.32 |
| DD[7] | 1.01 | 31.03 |
| DD[16] | 31.41 | 1.38 |
| DD[23] | 2.67 | 14.16 |
| DD[26] | 21.80 | 10.31 |

Example 6

| Sn | 8 | 9 | 27 | 28 |
|---|---|---|---|---|
| KA | 1.0000000E+00 | 1.0000000E+00 | 1.0000000E+00 | 1.0000000E+00 |
| A4 | 6.3654280E−05 | 5.8115700E−05 | −3.3313022E−07 | 1.5864674E−05 |
| A6 | −1.6520578E−06 | −8.6702710E−07 | −3.1035733E−07 | 4.6814967E−07 |
| A8 | 3.6308297E−08 | −4.5783717E−08 | 1.3953513E−08 | −2.8075495E−08 |
| A10 | −6.2436489E−10 | 3.8246956E−09 | −1.9091620E−10 | 9.8406524E−10 |
| A12 | 7.5884189E−12 | −1.3330761E−10 | −7.6081743E−13 | −1.9031014E−11 |
| A14 | −6.0903631E−14 | 2.6082780E−12 | 5.1744107E−14 | 2.1392501E−13 |
| A16 | 3.0342366E−16 | −2.9426472E−14 | −5.9555663E−16 | −1.3822383E−15 |
| A18 | −8.4569318E−19 | 1.7856370E−16 | 2.9430982E−18 | 4.7328661E−18 |
| A20 | 1.0050279E−21 | −4.5150703E−19 | −5.4890319E−21 | −6.6078617E−21 |

| Sn | 18 | 19 |
|---|---|---|
| KA | 1.0000000E+00 | 1.0000000E+00 |
| A3 | 0.0000000E+00 | 0.0000000E+00 |
| A4 | −3.8865422E−05 | 7.1075371E−05 |
| A5 | 7.6564967E−05 | −2.3245540E−05 |
| A6 | −7.1121281E−05 | 8.8240861E−06 |
| A7 | 3.1399739E−05 | −1.6886838E−06 |
| A8 | −7.0470848E−06 | 1.8063804E−07 |
| A9 | 5.5583077E−07 | −1.8197456E−08 |
| A10 | 9.7347054E−08 | 2.8022294E−09 |
| A11 | −2.8941874E−08 | −6.9908347E−11 |
| A12 | 2.6732043E−09 | −6.6561840E−11 |
| A13 | −2.3823750E−11 | 9.3073733E−12 |
| A14 | −1.4334971E−11 | −2.8836404E−13 |
| A15 | 1.0709284E−12 | −1.8458979E−14 |
| A16 | −2.5308020E−14 | 1.0024286E−15 |

Table 18 shows values related to Conditional Expressions (1) and (2) for the optical systems of Examples 1 to 6. In the leftmost column of Table 18, an example number and a corresponding reference numeral of the corresponding sub-stop are shown, and the magnification state of the values used for calculation is shown after the reference numeral of the sub-stop for the examples of the variable magnification optical system. Here, “Wide” indicates the wide angle end, and “Tele” indicates the telephoto end. This display method of the leftmost column also applies to Tables 19 to 22 described later. A sign of Dst is positive for the sign of the distance on the image side and is negative for the sign of the distance on the object side, with reference to the main stop FS. In Table 18, columns of the corresponding values of Conditional Expressions (1) and (2) are surrounded by thick lines with (1) and (2) shown above the columns, respectively.

Table 19 shows values related to Conditional Expressions (3) and (4) for the optical systems of Examples 1 to 6. Here, dhp={Rp−Rp×(1−(φEp/2)²/Rp²)^{1/2}} is established. In Table 19, columns of the corresponding values of Conditional Expressions (3) and (4) are surrounded by thick lines with (3) and (4) shown above the columns, respectively.

Table 20 shows values related to Conditional Expressions (5) and (6) for the optical systems of Examples 1 to 6. Here, dhn={Rn−Rn×(1−(φEn/2)²/Rn²)^{1/2}} is established. In Table 20, columns of the corresponding values of Conditional Expressions (5) and (6) are surrounded by thick lines with (5) and (6) shown above the columns, respectively.

Table 21 shows values related to Conditional Expressions (7) and (8) for the optical systems of Examples 1 to 6. A sign of Dst is defined in the same manner as that of Table 18. A sign of hp is positive for the height of the ray above the optical axis Z and is negative for the height of the ray below the optical axis Z in each cross-sectional view. In Table 21, columns of the corresponding values of Conditional Expressions (7) and (8) are surrounded by thick lines with (7) and (8) shown above the columns, respectively.

Table 22 shows values related to Conditional Expression (9) for the optical systems of Examples 1 to 6. In Table 22, a column of the corresponding value of Conditional Expression (9) is surrounded by thick lines with (9) shown above the column.

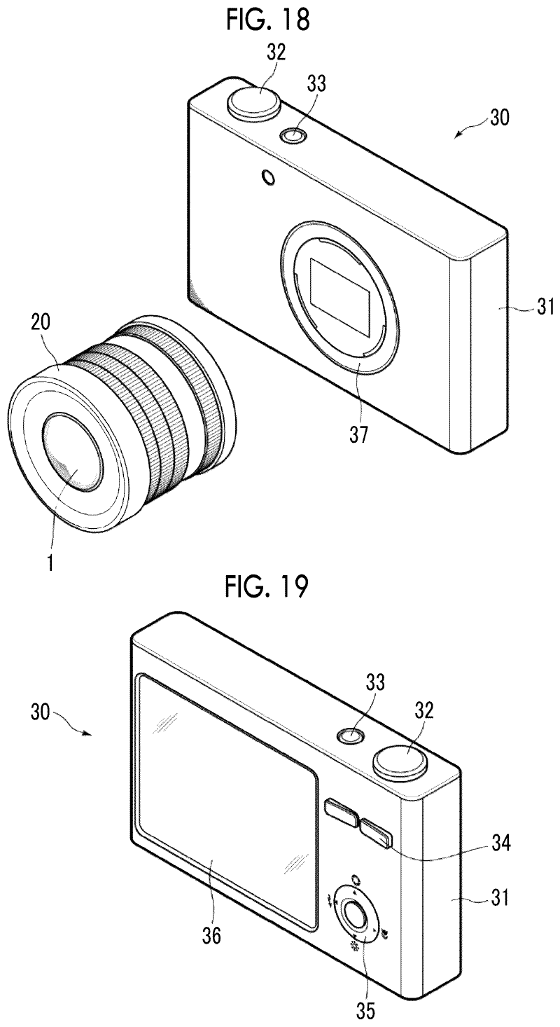

Next, an imaging apparatus according to the embodiment of the present disclosure will be described. FIGS. 18 and 19 illustrate external views of a camera 30 that is the imaging apparatus according to one embodiment of the present disclosure. FIG. 18 illustrates a perspective view of the camera 30 seen from a front surface side, and FIG. 19 illustrates a perspective view of the camera 30 seen from a rear surface side. The camera 30 is a so-called mirrorless type digital camera on which an interchangeable lens 20 can be attachably and detachably mounted. The interchangeable lens 20 is composed of an optical system 1 according to one embodiment of the present disclosure accommodated in a lens barrel.

The camera 30 comprises a camera body 31, and a shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

An imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the number of lenses and the number of lens groups constituting the optical system are not limited to those of the examples. The variable magnification optical system is not limited to a zoom lens and may be a varifocal lens. The sub-stop may be disposed on the object side with respect to the main stop FS or may be disposed on the image side with respect to the main stop FS. The number of sub-stops that are disposed in one optical system and that satisfy each conditional expression can be set to any number. The curvature radius, the surface spacing, the refractive index, the Abbe number, and the aspherical coefficient of each lens are not limited to the values shown in each example and may have other values.

The imaging apparatus according to the embodiment of the present disclosure is also not limited to the examples and can have various aspects of, for example, a camera of a type other than a mirrorless type, a film camera, a video camera, a video capturing camera, and a surveillance camera.

The following appendices are further disclosed with respect to the embodiment and the examples described above.

### Appendix 1

An optical system comprising a first stop having a variable opening diameter, three or more lenses that are disposed on an object side with respect to the first stop and that include a positive lens and a negative lens, and a second stop having a fixed opening diameter, in which, in a case where a distance on an optical axis from the first stop to the second stop is denoted by Dst, a focal length of the optical system is denoted by f, and in a case where the optical system is a variable magnification optical system, values of Dst and f in a magnification state where a height of an on-axis marginal ray from the optical axis is maximum at a position of the second stop are used, Conditional Expression (1) is satisfied, which is represented by

$$0.005 < \vert Dst \vert / f < 2. \qquad ( 1 )$$

### Appendix 2

The optical system according to Appendix 1, in which, in a case where the opening diameter of the first stop in an open state is denoted by φF, the opening diameter of the second stop is denoted by φS, and in a case where the optical system is the variable magnification optical system, values of φF and φS in the magnification state where the height of the on-axis marginal ray from the optical axis is maximum at the position of the second stop are used, Conditional Expression (2) is satisfied, which is represented by

$$0.3 < φ S / φ F < 2.5 . \qquad ( 2 )$$

Appendix 3

The optical system according to Appendix 1 or 2, in which a lens surface of a convex shape in contact with air is positioned in an opening of the second stop, and in a case where a distance on the optical axis from an intersection between the lens surface and the optical axis to the second stop having the opening in which the lens surface is positioned is denoted by Dp, for Dp, a sign of a distance on an image side is positive, and a sign of a distance on the object side is negative, with reference to the intersection, and a paraxial curvature radius of the lens surface is denoted by Rp, Conditional Expression (3) is satisfied, which is represented by

$$0 < Dp / Rp < 0.4 . \qquad ( 3 )$$

### Appendix 4

The optical system according to any one of Appendices 1 to 3, in which a lens surface of a convex shape in contact with air is positioned in an opening of the second stop, and in a case where a distance on the optical axis from an intersection between the lens surface and the optical axis to the second stop having the opening in which the lens surface is positioned is denoted by Dp, for Dp, a sign of a distance on an image side is positive, and a sign of a distance on the object side is negative, with reference to the intersection, a paraxial curvature radius of the lens surface is denoted by Rp, and an effective diameter of the lens surface is denoted by φEp, Conditional Expression (4) is satisfied, which is represented by

$$0.7 < \{ Rp - Rp \times {( 1 - {( φ Ep / 2 )}^{2} / {Rp}^{2} )}^{1 / 2} \} / Dp < 1.5 . \qquad ( 4 )$$

### Appendix 5

The optical system according to any one of Appendices 1 to 4, in which a lens surface of a concave shape in contact with air is positioned adjacent to the second stop, and in a case where a distance on the optical axis from an intersection between the lens surface and the optical axis to the second stop is denoted by Dn, for Dn, a sign of a distance on an image side is positive, and a sign of a distance on the object side is negative, with reference to the intersection, a paraxial curvature radius of the lens surface is denoted by Rn, in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn and Rn, and in a case where the optical system is the variable magnification optical system, a value of Dn in the magnification state where the height of the on-axis marginal ray from the optical axis is maximum at the position of the second stop is used, Conditional Expression (5) is satisfied, which is represented by

$$0 < Dn / Rn < 0.4 . \qquad ( 5 )$$

### Appendix 6

The optical system according to any one of Appendices 1 to 5, in which a lens surface of a concave shape in contact with air is positioned adjacent to the second stop, and in a case where a distance on the optical axis from an intersection between the lens surface and the optical axis to the second stop is denoted by Dn, for Dn, a sign of a distance on an image side is positive, and a sign of a distance on the object side is negative, with reference to the intersection, a paraxial curvature radius of the lens surface is denoted by Rn, an effective diameter of the lens surface is denoted by φEn, in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn, Rn, and φEn, and in a case where the optical system is the variable magnification optical system, a value of Dn in the magnification state where the height of the on-axis marginal ray from the optical axis is maximum at the position of the second stop is used, Conditional Expression (6) is satisfied, which is represented by

$$0.5 < \{ Rn - Rn \times {( 1 - {( φ En / 2 )}^{2} / {Rn}^{2} )}^{1 / 2} \} / Dn < 1.2 . \qquad ( 6 )$$

### Appendix 7

The optical system according to any one of Appendices 1 to 6, in which, in a case where a height of a principal ray having a maximum image height from the optical axis at the position of the second stop is denoted by hp, the height of the on-axis marginal ray from the optical axis at the position of the second stop is denoted by hm, and in a case where the optical system is the variable magnification optical system, values of hp and hm in the magnification state where the height of the on-axis marginal ray from the optical axis is maximum at the position of the second stop are used, Conditional Expression (7) is satisfied, which is represented by

$$0 < \vert h p \vert / hm < 1. \qquad ( 7 )$$

### Appendix 8

The optical system according to any one of Appendices 1 to 7, in which, in a case where a sum of a distance on the optical axis from a lens surface of the optical system closest to the object side to a lens surface of the optical system closest to an image side and a back focus of the optical system as an air conversion distance is denoted by TL, a height of a principal ray having a maximum image height from the optical axis at the position of the second stop is denoted by hp, the height of the on-axis marginal ray from the optical axis at the position of the second stop is denoted by hm, and in a case where the optical system is the variable magnification optical system, values of Dst, TL, hp, and hm in the magnification state where the height of the on-axis marginal ray from the optical axis is maximum at the position of the second stop are used, Conditional Expression (8) is satisfied, which is represented by

$$0.05 < ( \vert Dst \vert / TL ) / ( \vert h p \vert / hm ) < 1.8 . \qquad ( 8 )$$

### Appendix 9

The optical system according to any one of Appendices 1 to 8, in which, in a case where one lens component is one single lens or one cemented lens, a combined focal length of all lens components on the object side with respect to the second stop is denoted by fs, and in a case where the optical system is the variable magnification optical system, values of f and fs in the magnification state where the height of the on-axis marginal ray from the optical axis is maximum at the position of the second stop are used, Conditional Expression (9) is satisfied, which is represented by

$$- 5 < f / fs < 5. \qquad ( 9 )$$

### Appendix 10

The optical system according to any one of Appendices 1 to 9, in which the second stop moves in an integrated manner with at least one lens of the optical system during focusing, or the second stop is fixed with respect to an image plane in an integrated manner with at least one lens of the optical system during focusing, and in a case where the optical system is the variable magnification optical system, the second stop moves in an integrated manner with at least one lens of the optical system during changing magnification, or the second stop is fixed with respect to the image plane in an integrated manner with at least one lens of the optical system during changing the magnification.

### Appendix 11

The optical system according to any one of Appendices 1 to 10, in which the first stop is a stop for determining an F-number.

### Appendix 12

An imaging apparatus comprising the optical system according to any one of Appendices 1 to 11.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. An optical system comprising:
a first stop having a variable opening diameter;
three or more lenses that are disposed on an object side with respect to the first stop and that include a positive lens and a negative lens; and
a second stop having a fixed opening diameter,
wherein, in a case where a distance on an optical axis from the first stop to the second stop is denoted by Dst,
a focal length of the optical system is denoted by f, and
in a case where the optical system is a variable magnification optical system, values of Dst and f in a magnification state where a height of an on-axis marginal ray from the optical axis at a position of the second stop is maximum are used,
Conditional Expression (1) is satisfied, which is represented by
$$0.005 < \vert Dst \vert / f < 2. \qquad ( 1 )$$

2. The optical system according to claim 1,
wherein, in a case where the opening diameter of the first stop in an open state is denoted by φF,
the opening diameter of the second stop is denoted by φS, and
in a case where the optical system is the variable magnification optical system, values of φF and φS in the magnification state where the height of the on-axis marginal ray from the optical axis at the position of the second stop is maximum are used,
Conditional Expression (2) is satisfied, which is represented by
$$0.3 < φ S / φ F < 2.5 . \qquad ( 2 )$$

3. The optical system according to claim 1,
wherein a lens surface of a convex shape in contact with air is positioned in an opening of the second stop, and
in a case where a distance on the optical axis from an intersection between the lens surface and the optical axis to the second stop having the opening in which the lens surface is positioned is denoted by Dp,
for Dp, a sign of a distance on an image side is positive, and a sign of a distance on the object side is negative, with reference to the intersection, and
a paraxial curvature radius of the lens surface is denoted by Rp,
Conditional Expression (3) is satisfied, which is represented by
$$0 < Dp / Rp < 0.4 . \qquad ( 3 )$$

4. The optical system according to claim 1,
wherein a lens surface of a convex shape in contact with air is positioned in an opening of the second stop, and
in a case where a distance on the optical axis from an intersection between the lens surface and the optical axis to the second stop having the opening in which the lens surface is positioned is denoted by Dp,
for Dp, a sign of a distance on an image side is positive, and a sign of a distance on the object side is negative, with reference to the intersection,
a paraxial curvature radius of the lens surface is denoted by Rp, and
an effective diameter of the lens surface is denoted by φEp,
Conditional Expression (4) is satisfied, which is represented by
$$0.7 < \{ Rp - Rp \times {( 1 - {( φ Ep / 2 )}^{2} / {Rp}^{2} )}^{1 / 2} \} / Dp < 1.5 . \qquad ( 4 )$$

5. The optical system according to claim 1,
wherein a lens surface of a concave shape in contact with air is positioned adjacent to the second stop, and
in a case where a distance on the optical axis from an intersection between the lens surface and the optical axis to the second stop is denoted by Dn,
for Dn, a sign of a distance on an image side is positive, and a sign of a distance on the object side is negative, with reference to the intersection,
a paraxial curvature radius of the lens surface is denoted by Rn,
in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn and Rn, and
in a case where the optical system is the variable magnification optical system, a value of Dn in the magnification state where the height of the on-axis marginal ray from the optical axis at the position of the second stop is maximum is used,
Conditional Expression (5) is satisfied, which is represented by
$$0 < Dn / Rn < 0.4 . \qquad ( 5 )$$

6. The optical system according to claim 1,
wherein a lens surface of a concave shape in contact with air is positioned adjacent to the second stop, and
in a case where a distance on the optical axis from an intersection between the lens surface and the optical axis to the second stop is denoted by Dn,
for Dn, a sign of a distance on an image side is positive, and a sign of a distance on the object side is negative, with reference to the intersection,
a paraxial curvature radius of the lens surface is denoted by Rn,
an effective diameter of the lens surface is denoted by φEn,
in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn, Rn, and φEn, and
in a case where the optical system is the variable magnification optical system, a value of Dn in the magnification state where the height of the on-axis marginal ray from the optical axis at the position of the second stop is maximum is used,
Conditional Expression (6) is satisfied, which is represented by
$$0.5 < \{ Rn - Rn \times {( 1 - {( φ En / 2 )}^{2} / {Rn}^{2} )}^{1 / 2} \} / Dn < 1.2 . \qquad ( 6 )$$

7. The optical system according to claim 1,
wherein, in a case where a height of a principal ray having a maximum image height from the optical axis at the position of the second stop is denoted by hp,
the height of the on-axis marginal ray from the optical axis at the position of the second stop is denoted by hm, and
in a case where the optical system is the variable magnification optical system, values of hp and hm in the magnification state where the height of the on-axis marginal ray from the optical axis at the position of the second stop is maximum are used,
Conditional Expression (7) is satisfied, which is represented by
$$0 < \vert hp \vert / hm . \qquad ( 7 )$$

8. The optical system according to claim 1,
wherein, in a case where a sum of a distance on the optical axis from a lens surface of the optical system closest to the object side to a lens surface of the optical system closest to an image side and a back focus of the optical system as an air conversion distance is denoted by TL
a height of a principal ray having a maximum image height from the optical axis at the position of the second stop is denoted by hp,
the height of the on-axis marginal ray from the optical axis at the position of the second stop is denoted by hm, and
in a case where the optical system is the variable magnification optical system, values of Dst, TL, hp, and hm in the magnification state where the height of the on-axis marginal ray from the optical axis at the position of the second stop is maximum are used,
Conditional Expression (8) is satisfied, which is represented by
$$0.05 < ( \vert Dst \vert / TL ) / ( \vert hp \vert / hm ) < 1.8 . \qquad ( 8 )$$

9. The optical system according to claim 1,
wherein, in a case where one lens component is one single lens or one cemented lens,
a combined focal length of all lens components on the object side with respect to the second stop is denoted by fs, and
in a case where the optical system is the variable magnification optical system, values of f and fs in the magnification state where the height of the on-axis marginal ray from the optical axis at the position of the second stop is maximum are used,
Conditional Expression (9) is satisfied, which is represented by
$$- 5 < f / fs < 5. \qquad ( 9 )$$

10. The optical system according to claim 1,
wherein the second stop moves in an integrated manner with at least one lens of the optical system during focusing, or the second stop is fixed with respect to an image plane in an integrated manner with at least one lens of the optical system during focusing, and
in a case where the optical system is the variable magnification optical system, the second stop moves in an integrated manner with at least one lens of the optical system during changing magnification, or the second stop is fixed with respect to the image plane in an integrated manner with at least one lens of the optical system during changing the magnification.

11. The optical system according to claim 2, wherein a lens surface of a convex shape in contact with air is positioned in an opening of the second stop, and in a case where a distance on the optical axis from an intersection between the lens surface and the optical axis to the second stop having the opening in which the lens surface is positioned is denoted by Dp, for Dp, a sign of a distance on an image side is positive, and a sign of a distance on the object side is negative, with reference to the intersection, and a paraxial curvature radius of the lens surface is denoted by Rp, Conditional Expression (3) is satisfied, which is represented by
$$0 < Dp / Rp < 0.4 . \qquad ( 3 )$$

12. The optical system according to claim 2,
wherein a lens surface of a convex shape in contact with air is positioned in an opening of the second stop, and
in a case where a distance on the optical axis from an intersection between the lens surface and the optical axis to the second stop having the opening in which the lens surface is positioned is denoted by Dp,
for Dp, a sign of a distance on an image side is positive, and a sign of a distance on the object side is negative, with reference to the intersection,
a paraxial curvature radius of the lens surface is denoted by Rp, and
an effective diameter of the lens surface is denoted by φEp,
Conditional Expression (4) is satisfied, which is represented by
$$0.7 < \{ Rp - Rp \times {( 1 - {( φ Ep / 2 )}^{2} / {Rp}^{2} )}^{1 / 2} \} / Dp < 1.5 . \qquad ( 4 )$$

13. The optical system according to claim 2,
wherein a lens surface of a concave shape in contact with air is positioned adjacent to the second stop, and
in a case where a distance on the optical axis from an intersection between the lens surface and the optical axis to the second stop is denoted by Dn,
for Dn, a sign of a distance on an image side is positive, and a sign of a distance on the object side is negative, with reference to the intersection,
a paraxial curvature radius of the lens surface is denoted by Rn,
in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn and Rn, and
in a case where the optical system is the variable magnification optical system, a value of Dn in the magnification state where the height of the on-axis marginal ray from the optical axis at the position of the second stop is maximum is used,
Conditional Expression (5) is satisfied, which is represented by
$$0 < Dn / Rn < 0.4 . \qquad ( 5 )$$

14. The optical system according to claim 2,
wherein a lens surface of a concave shape in contact with air is positioned adjacent to the second stop, and
in a case where a distance on the optical axis from an intersection between the lens surface and the optical axis to the second stop is denoted by Dn,
for Dn, a sign of a distance on an image side is positive, and a sign of a distance on the object side is negative, with reference to the intersection,
a paraxial curvature radius of the lens surface is denoted by Rn,
an effective diameter of the lens surface is denoted by φEn,
in a case where two lens surfaces of concave shapes in contact with air are positioned adjacent to the second stop, a value of a lens surface having a diameter of an effective optical surface closer to a value of the opening diameter of the second stop out of the two lens surfaces is used for Dn, Rn, and φEn, and
in a case where the optical system is the variable magnification optical system, a value of Dn in the magnification state where the height of the on-axis marginal ray from the optical axis at the position of the second stop is maximum is used,
Conditional Expression (6) is satisfied, which is represented by
$$0.5 < \{ Rn - Rn \times {( 1 - {( φ En / 2 )}^{2} / {Rn}^{2} )}^{1 / 2} \} / Dn < 1.2 . \qquad ( 6 )$$

15. The optical system according to claim 2,
wherein, in a case where a height of a principal ray having a maximum image height from the optical axis at the position of the second stop is denoted by hp,
the height of the on-axis marginal ray from the optical axis at the position of the second stop is denoted by hm, and
in a case where the optical system is the variable magnification optical system, values of hp and hm in the magnification state where the height of the on-axis marginal ray from the optical axis at the position of the second stop is maximum are used,
Conditional Expression (7) is satisfied, which is represented by
$$0 < \vert hp \vert / hm . \qquad ( 7 )$$

16. The optical system according to claim 2,
wherein, in a case where a sum of a distance on the optical axis from a lens surface of the optical system closest to the object side to a lens surface of the optical system closest to an image side and a back focus of the optical system as an air conversion distance is denoted by TL,
a height of a principal ray having a maximum image height from the optical axis at the position of the second stop is denoted by hp,
the height of the on-axis marginal ray from the optical axis at the position of the second stop is denoted by hm, and
in a case where the optical system is the variable magnification optical system, values of Dst, TL, hp, and hm in the magnification state where the height of the on-axis marginal ray from the optical axis at the position of the second stop is maximum are used,
Conditional Expression (8) is satisfied, which is represented by
$$0.05 < ( \vert Dst \vert / TL ) / ( \vert hp \vert / hm ) < 1.8 . \qquad ( 8 )$$

17. The optical system according to claim 2,
wherein, in a case where one lens component is one single lens or one cemented lens,
a combined focal length of all lens components on the object side with respect to the second stop is denoted by fs, and
in a case where the optical system is the variable magnification optical system, values of f and fs in the magnification state where the height of the on-axis marginal ray from the optical axis at the position of the second stop is maximum are used,
Conditional Expression (9) is satisfied, which is represented by
$$- 5 < f / fs < 5. \qquad ( 9 )$$

18. The optical system according to claim 2,
wherein the second stop moves in an integrated manner with at least one lens of the optical system during focusing, or the second stop is fixed with respect to an image plane in an integrated manner with at least one lens of the optical system during focusing, and
in a case where the optical system is the variable magnification optical system, the second stop moves in an integrated manner with at least one lens of the optical system during changing magnification, or the second stop is fixed with respect to the image plane in an integrated manner with at least one lens of the optical system during changing the magnification.

19. The optical system according to claim 1,
wherein the first stop is a stop for determining an F-number.

20. An imaging apparatus comprising:
the optical system according to claim 1.
